(19) United States
(12) Patent Application Publication
(10) Pub. No.: US 2013/0190510 A1
(43) Pub. Date: Jul. 25, 2013

(54) Neutral Tricoordinate Organoboron Derivatives Isoelectronic with Amines and Phosphines

(71) Applicants: Guy Bertrand, Riverside, CA (US); Rei Kinjo, Riverside, CA (US); Bruno Donnadieu, Riverside, CA (US)

(72) Inventors: Guy Bertrand, Riverside, CA (US); Rei Kinjo, Riverside, CA (US); Bruno Donnadieu, Riverside, CA (US)

(73) Assignee: The Regents of the University of California, Oakland, CA (US)

(21) Appl. No.: 13/556,103

(22) Filed: Jul. 23, 2012

Related U.S. Application Data
(60) Provisional application No. 61/510,987, filed on Jul. 22, 2011.

(51) Int. Cl. C07F 5/02

(52) U.S. Cl. CPC C07F 5/027
USPC 548/402; 548/405

(57) ABSTRACT

Amines and boranes are the archetypical Lewis bases and acids, respectively. The former can readily undergo one-electron oxidation to give radical cations, whereas the latter are easily reduced to afford radical anions. The present invention provides the synthesis of neutral tricoordinate boron derivatives, which act as a Lewis base, and undergoes one-electron oxidation into the corresponding radical cation. The present invention also provides borylene (H—B:) and borinylium (H—B⁺.) complexes stabilized by two cyclic (alkyl)(amino)carbenes. Ab initio calculations show that the HOMO [Highest Occupied Molecular Orbital] of the borane as well as the SOMO [Singly Occupied Molecular Orbital] of the radical cation are essentially a pair and a single electron in the p(π)-orbital of boron, respectively.

### CROSS-REFERENCES TO RELATED APPLICATIONS

This application claims priority to, and the benefit of, U.S. Provisional application Ser. No. 61/510,987 filed Jul. 22, 2011, the disclosure of which is incorporated herein by reference in its entirety.

### STATEMENT AS TO RIGHTS TO INVENTIONS MADE UNDER FEDERALLY SPONSORED RESEARCH OR DEVELOPMENT

This invention was made with Government support under Grant No. CHE0924410, awarded by the National Science Foundation and the Department of Defense Grant No. DE-FG02-09ER16069. The Government has certain rights in this invention.

### BACKGROUND OF THE INVENTION

The chemistry of boron is dominated by compounds in which the element adopts the +3 oxidation state and acts as a potent electron pair acceptor, or Lewis acid. To compensate its intrinsic electron-deficiency, boron also often participates in multicenter bonds, and numerous clusters involving hypervalent boron centers are known (R. N. Grimes, J. Chem. Educ., 81, 658 (2004)). At the opposite extreme, it is only recently that low-valent boron derivatives have been thoroughly explored (D. Vidovic, S. Aldridge, Chem. Sci., 2, 601 (2011); M. Yamashita, K. Nozaki, J. Synth. Org. Chem. Jap., 68, 359 (2010); R. C. Fischer, P. P. Power, Chem. Rev., 110, 3877 (2010); Y. Segawa, M. Yamashita, K. Nozaki, Science, 314, 113 (2006); T. B. Marder, Science, 314, 69 (2006); H. Braunschweig, Angew. Chem. Int. Ed., 46, 1946 (2007); K. Nozaki, Nature, 464, 1136 (2010); M. S. Cheung, T. B. Marder, Z. Lin, Organometallics, doi:10.1021/om200115y). Among these species, borylenes (BR), the subvalent boron(I) derivatives analogous to carbenes (CR₂) and nitrenes (NR), have been spectroscopically characterized in solid inert gas matrices at temperatures of a few K (P. Hassanzadeh, L. Andrews, J. Phys. Chem., 97, 4910 (1993); H. F. Bettinger, J. Am. Chem. Soc., 128, 2534 (2006)), but to date have eluded preparative isolation. Nonetheless, Braunschweig et al. (H. Braunschweig, C. Kollann, U. Englert, Angew. Chem. Int. Ed., 37, 3179 (1998)) have shown that borylenes can be incorporated into the ligand sphere of stable and isolable transition metal complexes (H. Braunschweig, R. D. Dewhurst, A. Schneider, Chem. Rev., 110, 3924 (2010)).

In recent years, stable singlet carbenes such as N-heterocyclic carbenes (NHCs) (F. E. Hahn, M. C. Jahnke, Angew. Chem. Int. Ed., 48, 950 (2008); D. Bourissou, O. Guerret, F. P. Gabbaï, G. Bertrand, Chem. Rev., 100, 39 (2000)) and cyclic (alkyl)(amino)carbenes (CAACs) (M. Melaimi, M. Soleilhavoup, G. Bertrand, Angew. Chem. Int. Ed., 49, 8810 (2010)) have proven as powerful as transition metal centers for stabilizing highly reactive main group element species (Y. Z. Wang, G. H. Robinson, Chem. Commun., 5201 (2009); D. Martin, M. Soleilhavoup, G. Bertrand, Chem. Sci., 2, 389 (2011)). In the boron series, Robinson and co-workers (Y. Wang et al., J. Am. Chem. Soc., 129, 12412 (2007); Y. Wang et al., J. Am. Chem. Soc., 130, 3298 (2008)) have reported that reduction of the (NHC)BBr₃ adduct A produced the isolable stable neutral diborene B, which can be regarded as a dimer of the parent borylene-carbene complex (FIG. 1). Using a similar synthetic approach, Braunschweig and co-workers (P. Bissinger et al., Angew. Chem. Int. Ed., 50, 4704 (2011)) have generated the parent borylene-carbene complex D, and although they were not able to characterize it spectroscopically, trapping experiments demonstrated its transient existence.

The extreme reactivity of borylenes is due to their two vacant orbitals as well as the presence of a lone pair of electrons. As such, there is a need in the field to which the present invention pertains related to the preparation, isolation, and use of organoboron derivatives wherein suitable carbene ligands stabilize a borylene complex. Because CAACs are slightly more nucleophilic, but considerably more electrophilic, than NHC ligands (V. Lavallo et al., Angew. Chem., Int. Ed., 45, 3488 (2006); 0. Back et al., Nature Chem., 2, 369 (2010); G. D. Frey et al., Science, 316, 439 (2007)), the present invention surprisingly found that CAACs are useful ligands for stabilizing a borylene complex.

### BRIEF SUMMARY OF THE INVENTION

The present invention provides novel organoboron complexes that are isoelectronic with amines and phosphines.

In one aspect, the present invention provides a tricoordinate borylene complex, having Formula I:

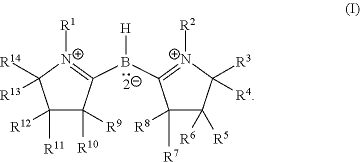

In Formula I, R¹ and R² are independently alkyl, aryl, arylalkyl, cycloalkyl, cycloalkylalkyl, heteroaryl, heteroarylalkyl, heterocycloalkyl, or heterocycloalkylalkyl. R⁷, R⁸, R⁹, and R¹⁰ are independently hydrogen, alkyl, aryl, arylalkyl, cycloalkyl, cycloalkylalkyl, heteroaryl, heteroarylalkyl, heterocycloalkyl, or heterocycloalkylalkyl. At least one of R⁷ and R⁸ is other than hydrogen. At least one of R⁹ and R¹⁰ is other than hydrogen. R³, R⁴, R⁵, R⁶, R¹¹, R¹², R¹³, and a R¹⁴ are independently hydrogen, acyl, alkyl, alkoxy, amino, aryl, arylalkyl cyano, cycloalkyl, cycloalkylalkyl, halo, heteroaryl, heteroarylalkyl, heterocycloalkyl, heterocycloalkylalkyl, hydroxyl, or nitro. R¹, R², R³, R⁴, R⁵, R⁶, R⁷, R⁸, R⁹, R¹⁰, R¹¹, R¹², R¹³, and R¹⁴ are independently optionally substituted with 1-5 substituents selected from the group consisting of alkyl, alkoxy, amino, aryl, cycloalkyl, halo, heteroaryl, hydroxyl, and nitro. Also included are the salts, hydrates, and isomers of Formula I.

In a second aspect, the present invention provides a stable borinylium radical, having Formula II:

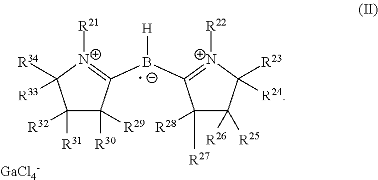

In Formula II, R²¹ and R²² are independently alkyl, aryl, arylalkyl, cycloalkyl, cycloalkylalkyl, heteroaryl, heteroarylalkyl, heterocycloalkyl, or heterocycloalkylalkyl. R²⁷, R²⁸, R²⁹, and R³⁰ are independently hydrogen, alkyl, aryl, arylalkyl, cycloalkyl, cycloalkylalkyl, heteroaryl, heteroarylalkyl, heterocycloalkyl, or heterocycloalkylalkyl. At least one of R²⁷ and R²⁸ is other than hydrogen. At least one of R²⁹ and R³⁰ is other than hydrogen. R²³, R²⁴, R²⁵, R²⁶, R³¹, R³², R³³, and R³⁴ are independently hydrogen, acyl, alkyl, alkoxy, amino, aryl, arylalkyl, cyano, cycloalkyl, cycloalkylalkyl, halo, heteroaryl, heteroarylalkyl, heterocycloalkyl, heterocycloalkylalkyl, hydroxyl, or nitro. R²¹, R²², R²³, R²⁴, R²⁵, R²⁶, R²⁷, R²⁸, R²⁹, R³⁰, R³¹, R³², R³³, and R³⁴ are independently optionally substituted with 1-5 substituents selected from the group consisting of alkyl, alkoxy, amino, aryl, cycloalkyl, halo, heteroaryl, hydroxyl, and nitro. Also included are the hydrates and isomers of Formula II.

In a third aspect, the present invention provides a boronium salt, having Formula III:

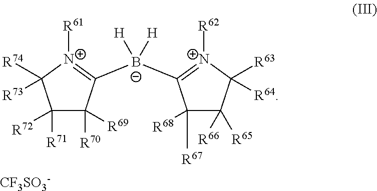

In Formula III, R⁶¹ and R⁶² are independently alkyl, aryl, arylalkyl, cycloalkyl, cycloalkylalkyl, heteroaryl, heteroarylalkyl, heterocycloalkyl, or heterocycloalkylalkyl. R⁶⁷, R⁶⁸, R⁶⁹, and R⁷⁰ are independently hydrogen, alkyl, aryl, arylalkyl, cycloalkyl, cycloalkylalkyl, heteroaryl, heteroarylalkyl, heterocycloalkyl, or heterocycloalkylalkyl. At least one of R⁶⁷ and R⁶⁸ is other than hydrogen. At least one of R⁶⁹ and R⁷⁰ is other than hydrogen. R⁶³, R⁶⁴, R⁶⁵, R⁶⁶, R⁷¹, R⁷², R⁷³, and R⁷⁴ are independently hydrogen, acyl, alkyl, alkoxy, amino, aryl, arylalkyl, cyano, cycloalkyl, cycloalkylalkyl, halo, heteroaryl, heteroarylalkyl, heterocycloalkyl, heterocycloalkylalkyl, hydroxyl, or nitro. R⁶¹, R⁶², R⁶³, R⁶⁴, R⁶⁵, R⁶⁶, R⁶⁷, R⁶⁸, R⁶⁹, R⁷⁰, R⁷¹, R⁷², R⁷³, and R⁷⁴ are independently optionally substituted with 1-5 substituents selected from the group consisting of alkyl, alkoxy, amino, aryl, cycloalkyl, halo, heteroaryl, hydroxyl, and nitro. Also included are the hydrates and isomers of Formula III.

In a fourth aspect, the present invention provides a transition metal complex including a transition metal and a complex of Formulas I, II, or III.

In a fifth aspect, the present invention provides a method of preparing a stable tricoordinate boron in the +1 oxidative state by stabilizing a borylene center with a pair of carbene ligands. The methods includes contacting a boron trihalide with a pair of carbene ligands to form a complex and contacting the complex with KC₈ in toluene.

In a sixth aspect, the present invention provides a tricoordinate borylene complex prepared according to the methods set forth herein.

In a seventh aspect, the present invention provides a method of catalyzing a reaction including combining a reactant with the transition metal complex as set forth herein under conditions sufficient for catalysis to occur.

### BRIEF DESCRIPTION OF THE DRAWINGS

FIG. 1. (Top) Synthesis of the neutral bis(carbene)-stabilized diborene B, the dimer of the parent borylene-NHC adduct, by Robinson and coworkers (Y. Wang et al., J. Am. Chem. Soc., 129, 12412 (2007); Y. Wang et al., J. Am. Chem. Soc., 130, 3298 (2008)) (Dipp: 2,6-diisopropylphenyl). (Bottom) Generation of a transient parent borylene-NHC adduct D by Braunschweig and coworkers (P. Bissinger et al., Angew. Chem. Int. Ed., 50, 4704 (2011)) (Np: Naphthalene).

FIG. 2. Synthesis of the parent borylene-bis(CAAC) adduct 3 represented under two canonical forms, its oxidation with gallium trichloride to the stable radical cation 3⁺, and its protonation with trifluoromethanesulfonic acid to afford the boronium salt [3H⁺]CF₃SO₃— (Dipp: 2,6-diisopropylphenyl).

FIG. 3. Molecular views (50% thermal ellipsoids are shown) of the parent borylene-bis(CAAC) 3 (left), radical cation 3⁺. (center), and boronium 3H⁺ (right) in the solid state (for clarity H atoms of the carbene ligand and the counterions GaCl₄⁻ for 3⁺ and CF₃SO₃⁻ for 3H⁺ are omitted. Selected bond lengths (Å) and angles (°) are given in the Table; for comparison, the calculated values at the (U)BP86/def2-SVP level of theory are given in brackets.

FIG. 4. Plot of the calculated highest-lying occupied molecular orbital (HOMO) (−3.34 eV) of the parent borylene-bis(CAAC) 3 (left), and singly occupied molecular orbital (SOMO) (−7.30 eV) of the radical cation 3⁺ (right).

FIG. 5. The FTIR spectrum of 3 in the solid state.

FIG. 6. The Cyclic voltammogram of a THE solution of 3 (01 M nBu₄NPF₆ as electrolyte, scan rate 100 mVs⁻¹, potential versus Fc⁺/Fc).

FIG. 7. Experimental EPR spectrum (9.3305 GHz) of [3⁺.]GaCl₄⁻ in THF at 298 K (top), and the computer simulation with Win Sim 2002 program (bottom).

FIG. 8. Schematic representation of the donor-acceptor bonding in the compound 3.

FIG. 9. Plot of the frontier orbitals of 3 and 3⁺. The eigenvalues (eV) are calculated at (U)BP86/def2-SVP.

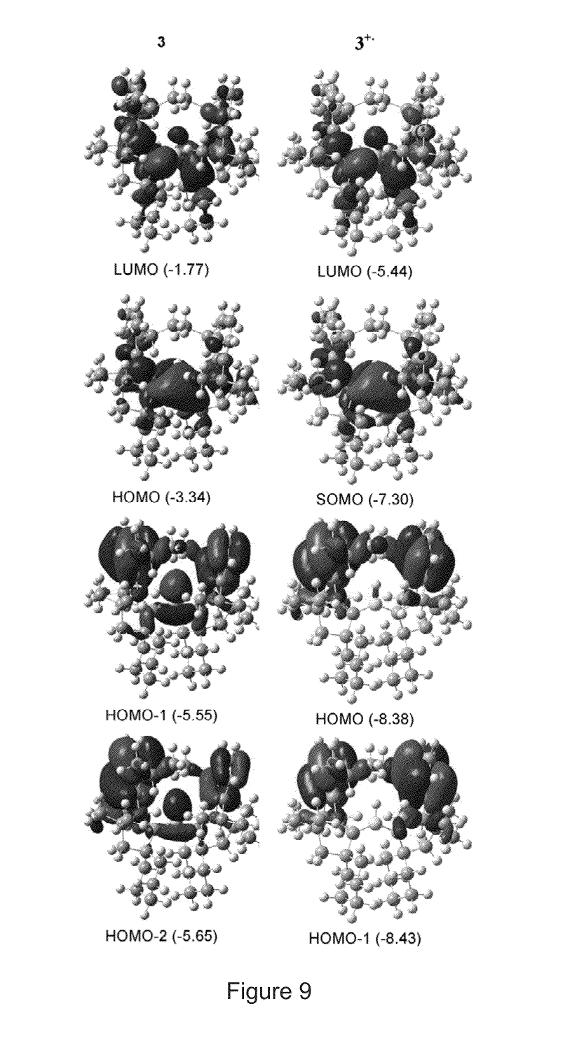

FIG. 10. The Spin density and the NBO (45) charges of the radical cation 3⁺. at UBP86/def2-SVP.

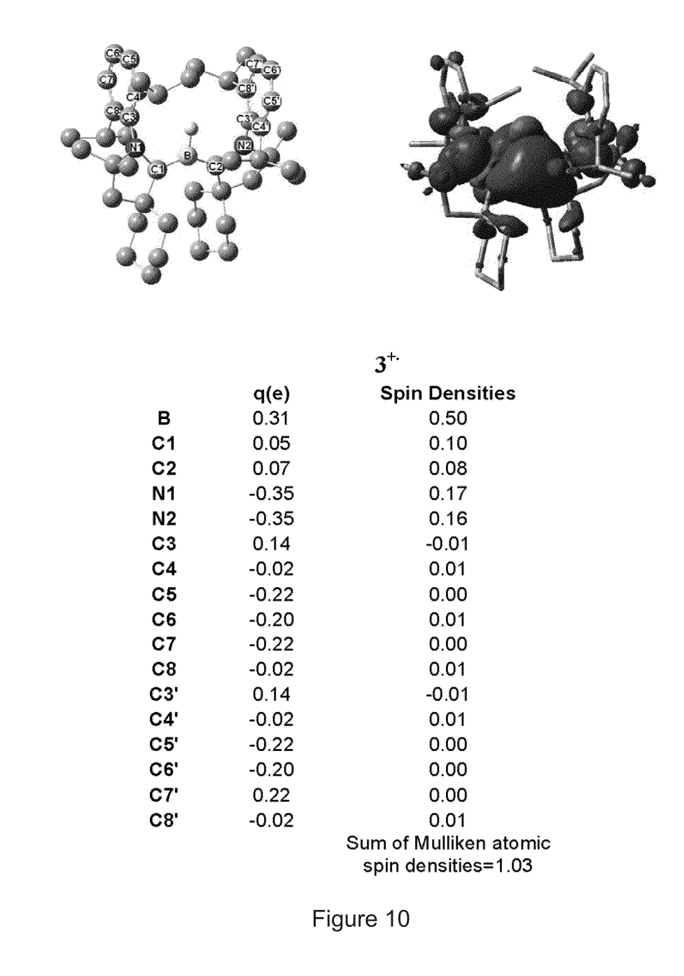

### DETAILED DESCRIPTION OF THE INVENTION

### I. General

The present invention provides organoboron complexes and derivatives, including neutral tricoordinate boron derivatives, as well as methods of making the same, which act as Lewis bases and undergoes one-electron oxidation into corresponding radical cations. The present invention also provides borylene (H—B:) and borinylium (H—B⁺.) complexes stabilized by two cyclic (alkyl)(amino)carbenes as well as methods of making the same. The present invention demonstrates that neutral tricoordinate organoboron, featuring boron in the +1 oxidation state, can be oxidized to afford the corresponding stable radical cation, and also protonated to give the conjugate acid.

### II. Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

As used herein, the term “alkyl” refers to a straight or branched, saturated, aliphatic radical having one to six carbon atoms, unless otherwise indicated (e.g., alkyl includes methyl, ethyl, propyl, isopropyl, butyl, sec-butyl, isobutyl, tert-butyl, and the like).

Alkyl represented along with another radical (e.g., as in arylalkyl; heteroarylalkyl; cycloalkylalkyl; or heterocycloalkylalkyl) means a straight or branched, saturated aliphatic divalent radical having the number of atoms indicated (e.g., aralkyl includes benzyl, phenethyl, 1-phenylethyl 3-phenylpropyl, and the like). It should be understood that any combination term using an “alk” or “alkyl” prefix refers to analogs according to the above definition of “alkyl”. For example, terms such as “alkoxy” “alkylhio” refer to alkyl groups linked to a second group via an oxygen or sulfur atom.

As used herein, the term “alkylene” refers to either a straight chain or branched alkylene of 1 to 7 carbon atoms, i.e. a divalent hydrocarbon radical of 1 to 7 carbon atoms; for instance, straight chain alkylene being the bivalent radical of Formula —(CH₂)ₙ—, where n is 1, 2, 3, 4, 5, 6 or 7. Preferably alkylene represents straight chain alkylene of 1 to 4 carbon atoms, e.g. a methylene, ethylene, propylene or butylene chain, or the methylene, ethylene, propylene or butylene chain mono-substituted by C₁-C₃-alkyl (preferably methyl) or disubstituted on the same or different carbon atoms by C₁-C₃-alkyl (preferably methyl), the total number of carbon atoms being up to and including 7. One of skill in the art will appreciate that a single carbon of the alkylene can be divalent, such as in —(HC(CH₂)ₙCH₃)—, wherein n=0-5.

As used herein, the term “alkoxy” refers to a radical —OR where R is an alkyl group as defined above e.g., methoxy, ethoxy, and the like.

As used herein, the term “amino” means the radical —NH₂. Unless indicated otherwise, the compounds of the invention containing amino moieties include protected derivatives thereof. Suitable protecting groups for amino moieties include acetyl, tert-butoxycarbonyl, benzyloxycarbonyl, and the like.

As used herein, the term “aryl” refers to a monocyclic or fused bicyclic, tricyclic or greater, aromatic ring assembly containing 6 to 16 ring carbon atoms. For example, aryl may be phenyl, benzyl or naphthyl, preferably phenyl. “Arylene” means a divalent radical derived from an aryl group. Aryl groups can be mono, di, or tri substituted by one, two or three radicals selected from alkyl, alkoxy, aryl, hydroxy, halogen, cyano, amino, amino alkyl, trifluoromethyl, alkylenedioxy and oxy C₂-C₃ alkylene, or 1 or 2 naphthyl; or 1 or 2 phenanthrenyl.

As used herein, the term “aralkyl” means a radical -(alkylene)-R where R is aryl as defined above e.g., benzyl, phenethyl, and the like.

As used herein, the term “cycloalkyl” refers to a saturated or partially unsaturated, monocyclic, fused bicyclic or bridged polycyclic ring assembly containing from 3 to 12 ring atoms, or the number of atoms indicated. For example, C₃-C₈ cycloalkyl includes cyclopropyl, cyclobutyl, cyclopentyl, cyclohexyl, cycloheptyl, and cyclooctyl. Cycloalkyl also includes norbornyl and adamantyl.

As used herein, the term “cycloalkylalkyl” means a radical -(alkylene)-R where R is cycloalkyl as defined above.

As used herein, the term “cyclic (alkyl)(amino)carbene” refers to a carbene having a cycloalkyl group and an amino group bonded together, e.g., the cyclic (alkyl)(amino)carbene may include

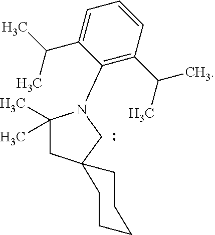

The amino group may be in a straight chain or as a cyclic group such as a heterocyclic carbene or an N-heterocyclic carbene. Example cyclic (alkyl)(amino)carbenes (CAACs) are set forth in M. Melaimi, M. Soleilhavoup, G. Bertrand, Angew. Chem. Int. Ed., 49, 8810. (2010))

As used herein, the terms “halo” or “halogen,” by themselves or as part of another substituent, mean, unless otherwise stated, a fluorine, chlorine, bromine, or iodine atom.

As used herein, the terms “heterocycloalkyl” and “heterocyclic” refer to a ring system having from 3 ring members to about 20 ring members and from 1 to about 5 heteroatoms such as N, O and S. For example, heterocycle includes, but is not limited to, tetrahydrofuranyl, tetrahydrothiophenyl, morpholino, pyrrolidinyl, pyrrolinyl, imidazolidinyl, imidazolinyl, pyrazolidinyl, pyrazolinyl, piperazinyl, piperidinyl, indolinyl, quinuclidinyl and 1,4-dioxa-8-aza-spiro[4.5]dec-8-yl.

As used herein, the term “heterocycloalkylalkyl” means a radical -(alkylene)-R where R is heterocycloalkyl as defined above.

As used herein, the term “heteroaryl” refers to a monocyclic or fused bicyclic or tricyclic aromatic ring assembly containing 5 to 16 ring atoms, where from 1 to 4 of the ring atoms are a heteroatom each N, O or S. For example, heteroaryl includes pyridyl, indolyl, indazolyl, quinoxalinyl, quinolinyl, isoquinolinyl, benzothienyl, benzofuranyl, furanyl, pyrrolyl, thiazolyl, benzothiazolyl, oxazolyl, isoxazolyl, triazolyl, tetrazolyl, pyrazolyl, imidazolyl, thienyl, or any other radicals substituted, especially mono or di substituted, by e.g. alkyl, nitro or halogen. Pyridyl represents 2, 3, or 4 pyridyl, advantageously 2 or 3 pyridyl. Thienyl represents 2 or 3 thienyl. Quinolinyl represents preferably 2, 3, or 4 quinolinyl. Isoquinolinyl represents preferably 1, 3, or 4 isoquinolinyl. Benzopyranyl, benzothiopyranyl represents preferably 3 benzopyranyl or 3 benzothiopyranyl, respectively. Thiazolyl represents preferably 2 or 4 thiazolyl, and most preferred, 4 thiazolyl. Triazolyl is preferably 1, 2, or 5 (1,2,4 triazolyl). Tetrazolyl is preferably 5 tetrazolyl.

As used herein, the term “heteroaralkyl” means a radical -(alkylene)-R where R is heteroaryl as defined above.

Preferably, heteroaryl is pyridyl, indolyl, quinolinyl, pyrrolyl, thiazolyl, isoxazolyl, triazolyl, tetrazolyl, pyrazolyl, imidazolyl, thienyl, furanyl, benzothiazolyl, benzofuranyl, isoquinolinyl, benzothienyl, oxazolyl, indazolyl, or any of the radicals substituted, especially mono or di substituted.

Substituents for the aryl and heteroaryl groups are varied and are selected from: halogen, OR′, OC(O)R′, NR′R″, SR′, R′, CN, NO₂, CO₂R′, CONR′R″, C(O)R′, OC(O)NR′R″, NR″C(O)R′, NR″C(O)₂R′, NR′C(O)NR″R″′, NH C(NH₂)═NH, NR′C(NH₂)═NH, NH C(NH₂)═NR′, S(O)R′, S(O)₂R′, S(O)₂NR′R″, N₃, CH(Ph)₂, perfluoro(C₁-C₄)alkoxy, and perfluoro(C₁-C₄)alkyl, in a number ranging from zero to the total number of open valences on the aromatic ring system; and where R′, R″ and R′″ are independently selected from hydrogen, C₁-C₈alkyl and heteroalkyl, unsubstituted aryl and heteroaryl, (unsubstituted aryl) (C₁-C₄)alkyl, and (unsubstituted aryl)oxy (C₁-C₄)alkyl.

As used herein, the term “hydroxyl” refers to the radical having the formula OH.

Each of the above terms (e.g., “alkyl,” “heteroalkyl,” “aryl” and “heteroaryl”), when indicated as “substituted” or “optionally substituted,” are meant to include both substituted and unsubstituted forms of the indicated radical.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to: —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″, —NR—C(NR′R″)═NR′″, —S(O)R′, —S(O)₂R′, —S(O)₂NR′R″, —NR(SO₂)R′, —CN and —NO₂ in a number ranging from zero to (2m′+1), where m′ is the total number of carbon atoms in such radical. R′, R″, R′″ and R′″ are each independently selected from hydrogen, C₁-C₈ alkyl and heteroalkyl, unsubstituted aryl and heteroaryl, (unsubstituted aryl)-(C₁-C₄)alkyl, and (unsubstituted aryl)oxy-(C₁-C₄)alkyl. When a compound of the invention includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 4-, 5-, 6-, or 7-membered ring. For example, —NR′R″ is meant to include, but not be limited to, 1-pyrrolidinyl and 4-morpholinyl. From the above discussion of substituents, one of skill in the art will understand that the term “substituted alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

As used herein, the term “i-Pr” refers to isopropyl, e.g.,

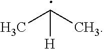

As used herein, the term “KC₈” refers to potassium graphite.

As used herein, the term “salt” refers to acid or base salts of the compounds used in a method of the present invention. Illustrative examples of acceptable salts are mineral acid (hydrochloric acid, hydrobromic acid, phosphoric acid, and the like) salts, organic acid (acetic acid, propionic acid, glutamic acid, trifluoroacetic acid, trifluoromethanesulfonic acid, citric acid and the like) salts, quaternary ammonium (methyl iodide, ethyl iodide, and the like) salts.

As used herein, the term “isomers” refers to compounds having the same number and kind of atoms, and hence the same molecular weight, but differing in respect to the structural arrangement or configuration of the atoms.

As used herein, the terms “a,” “an,” or “a(n)”, when used in reference to a group of substituents or “substituent group” herein, mean at least one. For example, where a compound is substituted with “an” alkyl or aryl, the compound is optionally substituted with at least one alkyl and/or at least one aryl, wherein each alkyl and/or aryl is optionally different. In another example, where a compound is substituted with “a” substituent group, the compound is substituted with at least one substituent group, wherein each substituent group is optionally different.

Description of compounds of the present invention are limited by principles of chemical bonding known to those skilled in the art. Accordingly, where a group may be substituted by one or more of a number of substituents, such substitutions are selected so as to comply with principles of chemical bonding and to give compounds which are not inherently unstable and/or would be known to one of ordinary skill in the art as likely to be unstable under ambient conditions, such as aqueous, or neutral conditions.

### III. Compounds and Complexes

In one embodiment, the present invention provides a tricoordinate borylene complex, having the structure of Formula I:

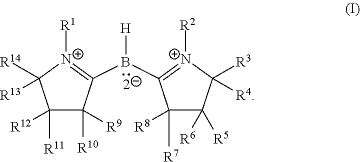

In Formula I, R¹ and R² are independently alkyl, aryl, arylalkyl, cycloalkyl, cycloalkylalkyl, heteroaryl, heteroarylalkyl, heterocycloalkyl, or heterocycloalkylalkyl. R⁷, R⁸, R⁹, and R¹⁰ are independently hydrogen, alkyl, aryl, arylalkyl, cycloalkyl, cycloalkylalkyl, heteroaryl, heteroarylalkyl, heterocycloalkyl, or heterocycloalkylalkyl. At least one of R⁷ and R⁸ is other than hydrogen. At least one of R⁹ and R¹⁰ is other than hydrogen. R³, R⁴, R⁵, R⁶, R¹¹, R¹², R¹³, and R¹⁴ are independently hydrogen, acyl, alkyl, alkoxy, amino, aryl, arylalkyl cyano, cycloalkyl, cycloalkylalkyl, halo, heteroaryl, heteroarylalkyl, heterocycloalkyl, heterocycloalkylalkyl, hydroxyl, or nitro. R¹, R², R³, R⁴, R⁵, R⁶, R⁷, R⁸, R⁹, R¹⁰, R¹¹, R¹², R¹³, and R¹⁴ are independently optionally substituted with 1-5 substituents selected from the group consisting of alkyl, alkoxy, amino, aryl, cycloalkyl, halo, heteroaryl, hydroxyl, and nitro. Also included are the salts, hydrates, and isomers thereof.

In some embodiments, the complex has the following structure:

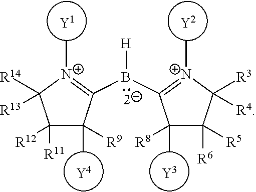

Y¹, Y², Y³, and Y⁴ are independently aryl, arylalkyl, cycloalkyl, or cycloalkylalkyl. Y¹, Y², Y³, and Y⁴ are independently optionally substituted with from 1-5 substituents selected from the group consisting of alkyl, aryl, halo, heteroaryl, and hydroxyl. In some embodiments, Y¹ or Y² is aryl or optionally both Y¹ and Y² are aryl. In some embodiments, Y¹ or Y² is 2,6-diisopropyl-phenyl or optionally both Y¹ and Y² are 2,6-diisopropyl-phenyl. In some other embodiments, Y³ or Y⁴ is cycloalkyl or optionally both Y³ and Y⁴ are cycloalkyl. In certain embodiments, Y³ or Y⁴ is cyclohexyl or optionally both Y³ and Y⁴ are cyclohexyl.

In some embodiments, the complex has the following structure:

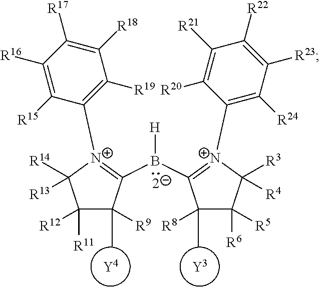

R¹⁵, R¹⁶, R¹⁷, R¹⁸, R¹⁹, R²⁰, R²¹, R²², R²³, and R²⁴ are independently hydrogen, acyl, alkyl, alkoxy, amino, cyano, halo, or nitro. In some embodiments, R¹⁵, R¹⁶, R²⁰, and R²⁴ are isopropyl.

In some of these embodiments, Y³ and Y⁴ are cyclohexyl.

In some embodiments, the complex has the following structure:

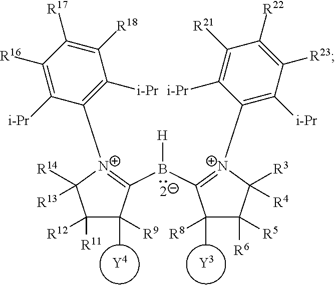

As used herein, i-Pr refers to isopropyl.

In other embodiments, the complex has the following structure:

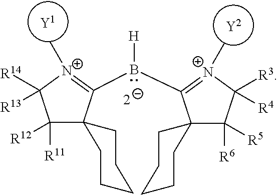

In still other embodiments, the complex has the following structure:

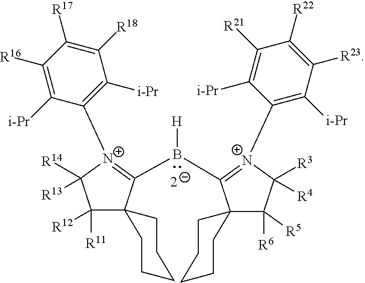

In other embodiments, the complex has the following structure:

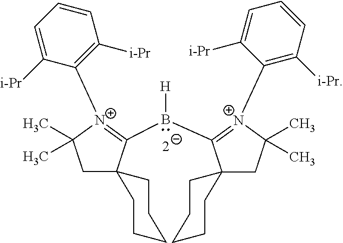

In other embodiments, the complex has the following resonance structure:

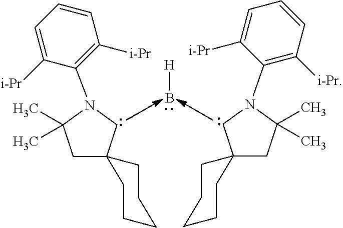

In some other embodiments, the present invention provides a stable borinylium radical having the structure of Formula II:

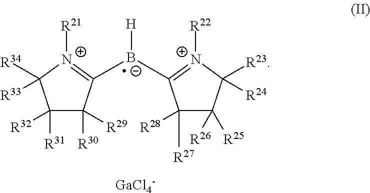

In Formula II, R²¹ and R²² are independently alkyl, aryl, arylalkyl, cycloalkyl, cycloalkylalkyl, heteroaryl, heteroarylalkyl, heterocycloalkyl, or heterocycloalkylalkyl. R²⁷, R²⁸, R²⁹, and R³⁰ are independently hydrogen, alkyl, aryl, arylalkyl, cycloalkyl, cycloalkylalkyl, heteroaryl, heteroarylalkyl, heterocycloalkyl, or heterocycloalkylalkyl. At least one of R²⁷ and R²⁸ is other than hydrogen. At least one of R²⁹ and R³⁰ is other than hydrogen. R²³, R²⁴, R²⁵, R²⁶, R³¹, R³², R³³, and R³⁴ are independently hydrogen, acyl, alkyl, alkoxy, amino, aryl, arylalkyl, cyano, cycloalkyl, cycloalkylalkyl, halo, heteroaryl, heteroarylalkyl, heterocycloalkyl, R²², R²³, R²⁴, R²⁵, R²⁶, R²⁷, R²⁸, R²⁹, R³⁰, R³¹, R³², heterocycloalkylalkyl, hydroxyl, or nitro. R²¹, R³³, and R³⁴ are independently optionally substituted with 1-5 substituents selected from the group consisting of alkyl, alkoxy, amino, aryl, cycloalkyl, halo, heteroaryl, hydroxyl, and nitro. Also included are the hydrates or isomers of Formula II. In certain embodiments, the GaCl₄⁻ is substituted for another suitable anion.

In some embodiments, the radical has the following structure:

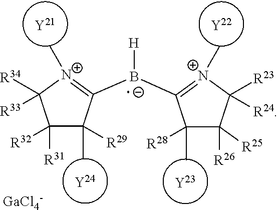

Y²¹, Y²², Y²³, and Y²⁴ are independently aryl, arylalkyl, cycloalkyl, or cycloalkylalkyl. Y²¹, Y²², Y²³, and Y²⁴ are independently optionally substituted with from 1-5 substituents selected from the group consisting of alkyl, aryl, halo, heteroaryl, and hydroxyl.

In certain embodiments, the radical has the following structure:

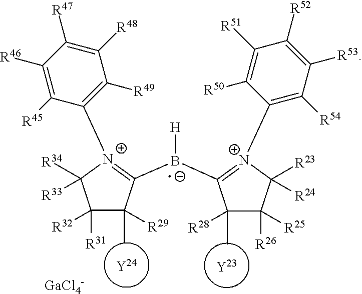

R⁴⁵, R⁴⁶, R⁴⁷, R⁴⁸, R⁴⁹, R⁵⁰, R⁵¹, R⁵², R⁵³, and R⁵⁴ are independently hydrogen, halo, acyl, alkyl, alkoxy, amino, cyano, or nitro.

In some embodiments, the radical has the following structure:

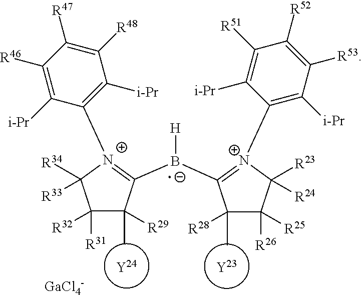

In other embodiments, the radical has the following structure:

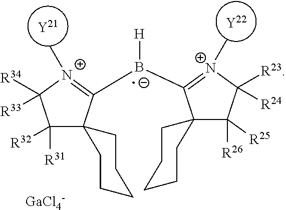

In other embodiments, the radical has the following structure:

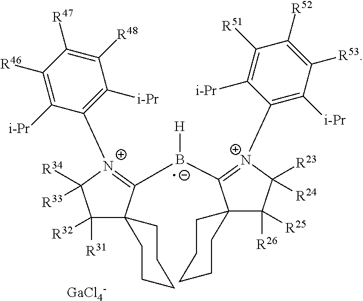

In some other embodiments, the radical has the following structure:

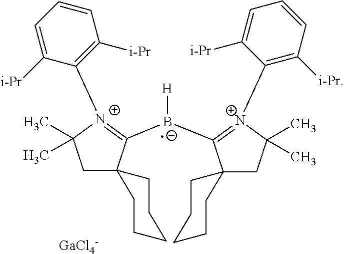

In other embodiments, the radical has the following resonance structure:

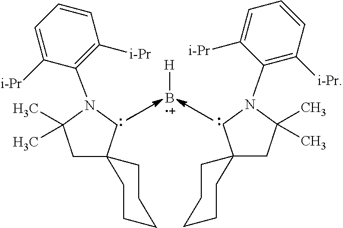

In certain embodiments, the present invention provides a boronium salt, having the structure of Formula III:

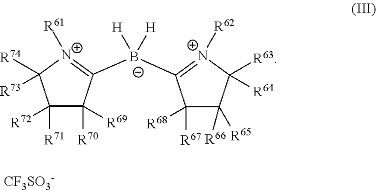

In Formula III, R⁶¹ and R⁶² are independently alkyl, aryl, arylalkyl, cycloalkyl, cycloalkylalkyl, heteroaryl, heteroarylalkyl, heterocycloalkyl, or heterocycloalkylalkyl. R⁶⁷, R⁶⁸, R⁶⁹, and R⁷⁰ are independently hydrogen, alkyl, aryl, arylalkyl, cycloalkyl, cycloalkylalkyl, heteroaryl, heteroarylalkyl, heterocycloalkyl, or heterocycloalkylalkyl. At least one of R⁶⁷ and R⁶⁸ is other than hydrogen. At least one of R⁶⁹ and R⁷⁰ is other than hydrogen. R⁶³, R⁶⁴, R⁶⁵, R⁶⁶, R⁷¹, R⁷², R⁷³, and R⁷⁴ are independently hydrogen, acyl, alkyl, alkoxy, amino, aryl, arylalkyl, cyano, cycloalkyl, cycloalkylalkyl, halo, heteroaryl, heteroarylalkyl, heterocycloalkyl, heterocycloalkylalkyl, hydroxyl, or nitro. R⁶¹, R⁶², R⁶³, R⁶⁴, R⁶⁵, R⁶⁶, R⁶⁷, R⁶⁸, R⁶⁹, R⁷⁰, R⁷¹, R⁷², R⁷³, and R⁷⁴ are independently optionally substituted with 1-5 substituents selected from the group consisting of alkyl, alkoxy, amino, aryl, cycloalkyl, halo, heteroaryl, hydroxyl, and nitro. Also included are the hydrates and isomers of Formula III. In other embodiments, the CF₃SO₃⁻ is substituted for another suitable anion.

In other embodiments, the salt has the following structure:

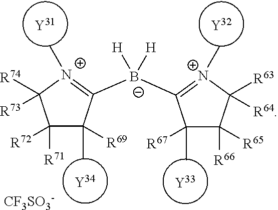

Y³¹, Y³², Y³³, and Y³⁴ are independently aryl, arylalkyl, cycloalkyl, or cycloalkylyl. Y³¹, Y³², Y³³, and Y³⁴ are independently optionally substituted with from 1-5 substituents selected from the group consisting of alkyl, aryl, halo, heteroaryl, and hydroxyl.

In other embodiments, the salt has the following structure:

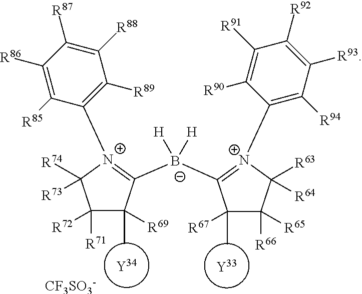

R⁸⁵, R⁸⁶, R⁸⁷, R⁸⁸, R⁸⁹, R⁹⁰, R⁹¹, R⁹², R⁹³, and R⁹⁴ are independently selected from the group consisting of hydrogen, halo, acyl, alkyl, alkoxy, amino, cyano, and nitro.

In other embodiments, the salt has the following structure:

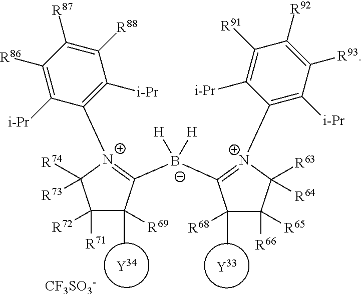

In some other embodiments, the salt has the following structure:

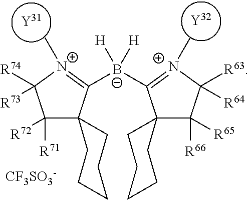

In certain embodiments, the salt has the following structure:

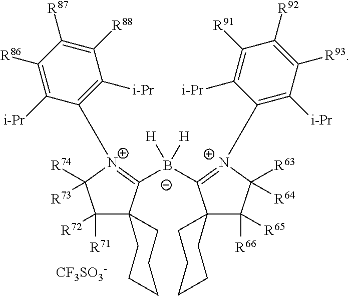

In other embodiments, the salt has the following structure:

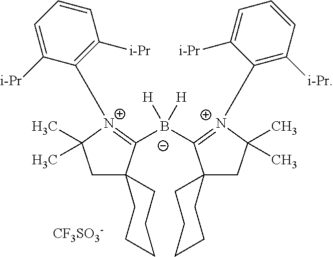 [SMILES: "CF3SO3-" ; CC(C)c1cccc(C(C)C)c1[N+]1=C([BH2-]C2=[N+](c3c(C(C)C)cccc3C(C)C)C(C)(C)CC23CCCCC3)C2(CCCCC2)CC1(C)C]

In certain other embodiments, the salt has the following resonance structure:

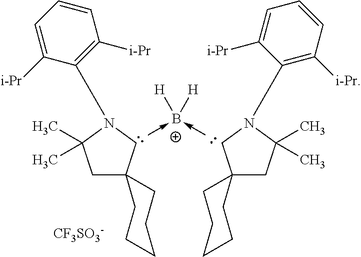

### IV. Transition Metal Complexes

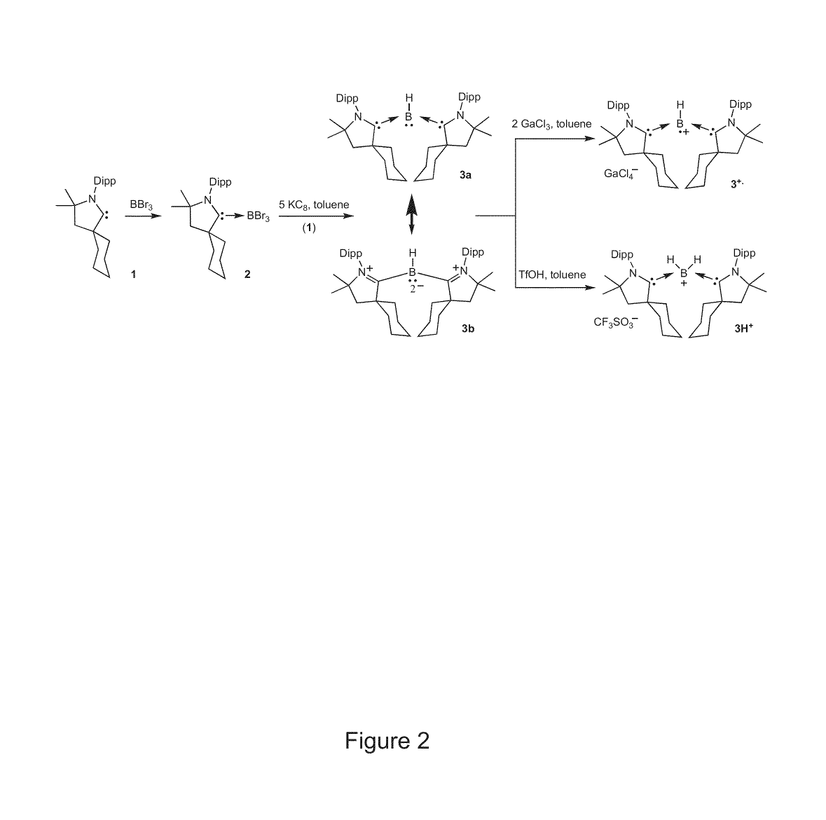

In other embodiments, the present invention provides a transition metal complex comprising a transition metal and a compound or complex of Formulas I, II, or III. In some embodiments, a compound or complex of Formulas I, II, or III is a tricoordinate boron, as set forth herein, wherein the boron is in the +1 oxidative state and is isoelectronic with an amine. In other embodiments, the present invention provides a transition metal complex, wherein the tricoordinate boron is in the +1 oxidative state and is substantially as provided in FIG. 2.

In some embodiments, the present invention provides metal complexes, including at least one ligand selected from Formulas I, II, or III that are useful as catalysts in a variety of organic reactions. One of skill in the art will appreciate that such complexes can employ a number of metals, including, but not limited to, transition metals, and have a variety of geometries (e.g., trigonal, square planar, trigonal bipyramidal and the like) depending on the nature of the metal and its oxidation state and other factors including, for example, additional ligands.

In some other embodiments, the present invention provides a coordination complex including a metal atom and at least one ligand selected from Formulas I, II, or III.

In some embodiments, the present invention provides a coordination complex including a metal atom and at least one ligand selected from Formulas I, II, or III, wherein the metal atom is selected from Li, Na, K, Rb, Cs, Be, Mg, Ca, Sr, Ba, Ra, Sc, Y, La, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Hg, Al, Ga, In, Tl, Ge, Sn, Pb, Sb, Bi, or Po. In some embodiments, the metal atom is selected from Ir, Pd, Rh Ru, or Au. In some other embodiments, the coordination complex further includes at least one ligand selected from halide, pseudohalide, tetraphenylborate, perhalogenated tetraphenylborate, tetrahaloborate, hexahalophosphate, hexahaloantimonate, trihalomethanesulfonate, alkoxide, carboxylate, tetrahaloaluminate, tetracarbonylcobaltate, hexahaloferrate(III), tetrahaloferrate(III), tetrahalopalladate(II), alkylsulfonate, arylsulfonate, perchlorate, cyanide, thiocyanate, cyanate, isocyanate, isothiocyanate, amines, imines, phosphines, phosphites, carbonyl compounds, alkenyl compounds, allyl compounds, carboxyl compounds, nitriles, alcohols, ethers, thiols or thioethers. In some embodiments, the coordination complex includes gold; a complex having Formulas I, II, or III; and optionally a member selected from bent-allenes, phosphines, sulfonated phosphines, phosphites, phosphinites, phosphonites, arsines, stibines, ethers, ammonia, amines, amides, sulfoxides, carbonyls, nitrosyls, pyridines and thioethers.

In general, any transition metal (e.g., a metal having d electrons) can be used to form the complexes/catalysts of the present invention. For example, suitable transition metals are those selected from one of Groups 3-12 of the periodic table or from the lanthanide series. Preferably, the metal will be selected from Groups 5-12 and even more preferably Groups 7-11. For example, suitable metals include platinum, palladium, iron, nickel, iridium, ruthenium and rhodium. The particular form of the metal to be used in the reaction is selected to provide, under the reaction conditions, metal centers which are coordinately unsaturated and not in their highest oxidation state.

To further illustrate, suitable transition metal complexes and catalysts include soluble or insoluble complexes of platinum, palladium, iridium, iron, rhodium, ruthenium and nickel. Palladium, rhodium, iridium, ruthenium and nickel are particularly preferred and palladium is most preferred.

The transition metal complexes of the present invention can include additional ligands as required to obtain a stable complex. The additional ligands can be neutral ligands, anionic ligands and/or electron-donating ligands. The ligand can be added to the reaction mixture in the form of a metal complex, or added as a separate reagent relative to the addition of the metal.

Anionic ligands suitable as additional ligands are preferably halide, pseudohalide, tetraphenylborate, perhalogenated tetraphenylborate, tetrahaloborate, hexahalophosphate, hexahaloantimonate, trihalomethanesulfonate, alkoxide, carboxylate, tetrahaloaluminate, tetracarbonylcobaltate, hexahaloferrate(III), tetrahaloferrate(III) or/and tetrahalopalladate(II). Preferably, an anionic ligand is selected from halide, pseudohalide, tetraphenylborate, perfluorinated tetraphenylborate, tetrafluoroborate, hexafluorophosphate, hexafluoroantimonate, trifluoromethanesulfonate, alkoxide, carboxylate, tetrachloroaluminate, tetracarbonylcobaltate, hexafluoroferrate (III), tetrachloroferrate(III) or/and tetrachloropalladate(II). Preferred pseudohalides are cyanide, thiocyanate, cyanate, isocyanate and isothiocyanate. Neutral or electron-donor ligands suitable as additional ligands can be, for example, amines, imines, phosphines, phosphites, carbonyl compounds, alkenyl compounds (e.g., allyl compounds), carboxyl compounds, nitriles, alcohols, ethers, thiols or thioethers. Still other suitable ligands can be carbene ligands such as the diaminocarbene ligands (e.g., N-heterocyclic carbenes).

While the present invention describes a variety of transition metal complexes useful in catalyzing organic reactions, one of skill in the art will appreciate that many of the complexes can be formed in situ. Accordingly, ligands (either carbene ligands or additional ligands) can be added to a reaction solution as a separate compound, or can be complexed to the metal center to form a metal-ligand complex prior to its introduction into the reaction solution. The additional ligands are typically compounds added to the reaction solution which can bind to the catalytic metal center. In some preferred embodiments, the additional ligand is a chelating ligand. While the additional ligands can provide stability to the catalytic transition metal complex, they may also suppress unwanted side reactions as well as enhance the rate and efficiency of the desired processes. Still further, in some embodiments, the additional ligands can prevent precipitation of the catalytic transition metal. Although the present invention does not require the formation of a metal-additional ligand complex, such complexes have been shown to be consistent with the postulate that they are intermediates in these reactions and it has been observed the selection of the additional ligand has an affect on the course of the reaction.

In related embodiments, the present invention provides metal complexes, of the type described above, in which the ligand having Formula I, II, or III has a pendent functionalized side chain (e.g., aminoalkyl, mercaptoalkyl, acyloxyalkyl and the like) in which the functional group acts as a ligand to provide a bidentate ligand feature. In still other embodiments, the ligand forms a metal complex with bidentate ligands that are not tethered to the cyclic carbene moiety.

In some embodiments, the present invention provides a reaction mixture including a coordination complex including a metal atom and at least one ligand selected from a compound or complex having Formula I, II, or III under conditions sufficient for catalysis to occur, a solvent and an olefin substrate, wherein said olefin substrate is selected to participate in an olefin metathesis reaction. In some other embodiments, the olefin substrate is selected as a substrate for ring closing metathesis. In some embodiments, the olefin substrate is selected as a substrate for ring opening polymerization metathesis. In some other embodiments, the olefin substrate is selected as a substrate for cross metathesis. In some embodiments, the olefin substrate is selected as a substrate for acyclic diene polymerization metathesis.

### V. Catalytic Reactions Suitable for Use with the Compounds and Complexes of the Present Invention

As noted above, the compounds and complexes of the present invention are useful in catalyzing a variety of organic reactions. The compounds and complexes of the present invention include neutral tricoordinate boron derivatives, which act as a Lewis base, and undergoes one-electron oxidation into the corresponding radical cation. Accordingly, the compounds and complexes of the present invention are useful for catalyzing Lewis base catalyzed reactions.

The reactions of the present invention can be performed under a wide range of conditions, and the solvents and temperature ranges recited herein should not be considered limiting. In general, it is desirable for the reactions to be run using mild conditions which will not adversely affect the reactants, the catalyst, or the product. For example, the reaction temperature influences the speed of the reaction, as well as the stability of the reactants and catalyst. The reactions will typically be run at temperatures in the range of 25° C. to 300° C., more preferably in the range 25° C. to 150° C.

Additionally, the reactions are generally carried out in a liquid reaction medium, but in some instances can be run without addition of solvent. For those reactions conducted in solvent, an inert solvent is preferred, particularly one in which the reaction ingredients, including the catalyst, are substantially soluble. Suitable solvents include ethers such as diethyl ether, 1,2-dimethoxyethane, diglyme, t-butyl methyl ether, tetrahydrofuran and the like; halogenated solvents such as chloroform, dichloromethane, dichloroethane, chlorobenzene, and the like; aliphatic or aromatic hydrocarbon solvents such as benzene, xylene, toluene, hexane, pentane and the like; esters and ketones such as ethyl acetate, acetone, and 2-butanone; polar aprotic solvents such as acetonitrile, dimethylsulfoxide, dimethylformamide and the like; or combinations of two or more solvents.

In some embodiments, reactions utilizing the catalytic complexes of the present invention can be run in a biphasic mixture of solvents, in an emulsion or suspension, or in a lipid vesicle or bilayer. In certain embodiments, the catalyzed reactions can be run in the solid phase with one of the reactants tethered or anchored to a solid support.

In certain embodiments it is preferable to perform the reactions under an inert atmosphere of a gas such as nitrogen or argon.

The reaction processes of the present invention can be conducted in continuous, semi-continuous or batch fashion and may involve a liquid recycle operation as desired. The processes of this invention are preferably conducted in batch fashion. Likewise, the manner or order of addition of the reaction ingredients, catalyst and solvent are also not generally critical to the success of the reaction, and may be accomplished in any conventional fashion.

The reaction can be conducted in a single reaction zone or in a plurality of reaction zones, in series or in parallel or it may be conducted batchwise or continuously in an elongated tubular zone or series of such zones. The materials of construction employed should be inert to the starting materials during the reaction and the fabrication of the equipment should be able to withstand the reaction temperatures and pressures. Means to introduce and/or adjust the quantity of starting materials or ingredients introduced batchwise or continuously into the reaction zone during the course of the reaction can be conveniently utilized in the processes especially to maintain the desired molar ratio of the starting materials. The reaction steps may be effected by the incremental addition of one of the starting materials to the other. Also, the reaction steps can be combined by the joint addition of the starting materials to the metal catalyst. When complete conversion is not desired or not obtainable, the starting materials can be separated from the product and then recycled back into the reaction zone.

The processes may be conducted in either glass lined, stainless steel or similar type reaction equipment. The reaction zone may be fitted with one or more internal and/or external heat exchanger(s) in order to control undue temperature fluctuations, or to prevent any possible “runaway” reaction temperatures.

Furthermore, one or more of the reactants can be immobilized or incorporated into a polymer or other insoluble matrix by, for example, derivativation with one or more of substituents of the aryl group.

### VI. Methods of Making the Compounds and Complexes of the Present Invention

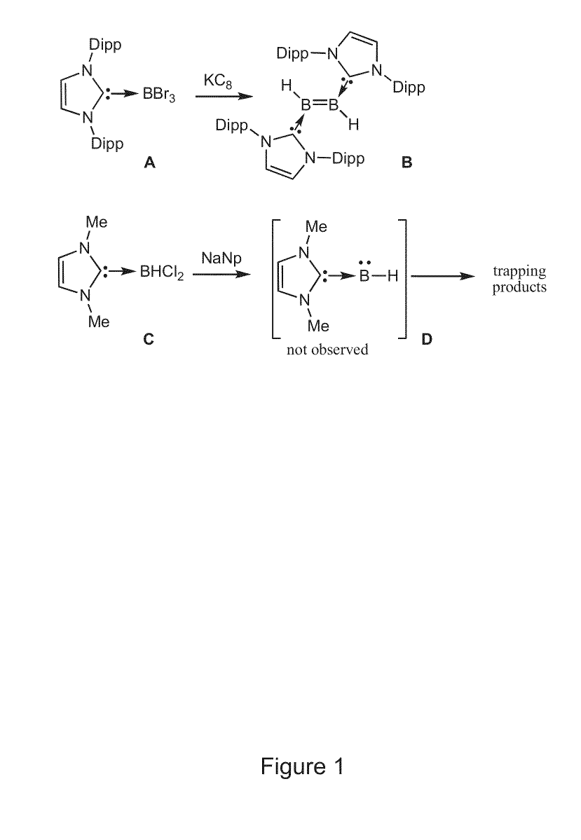

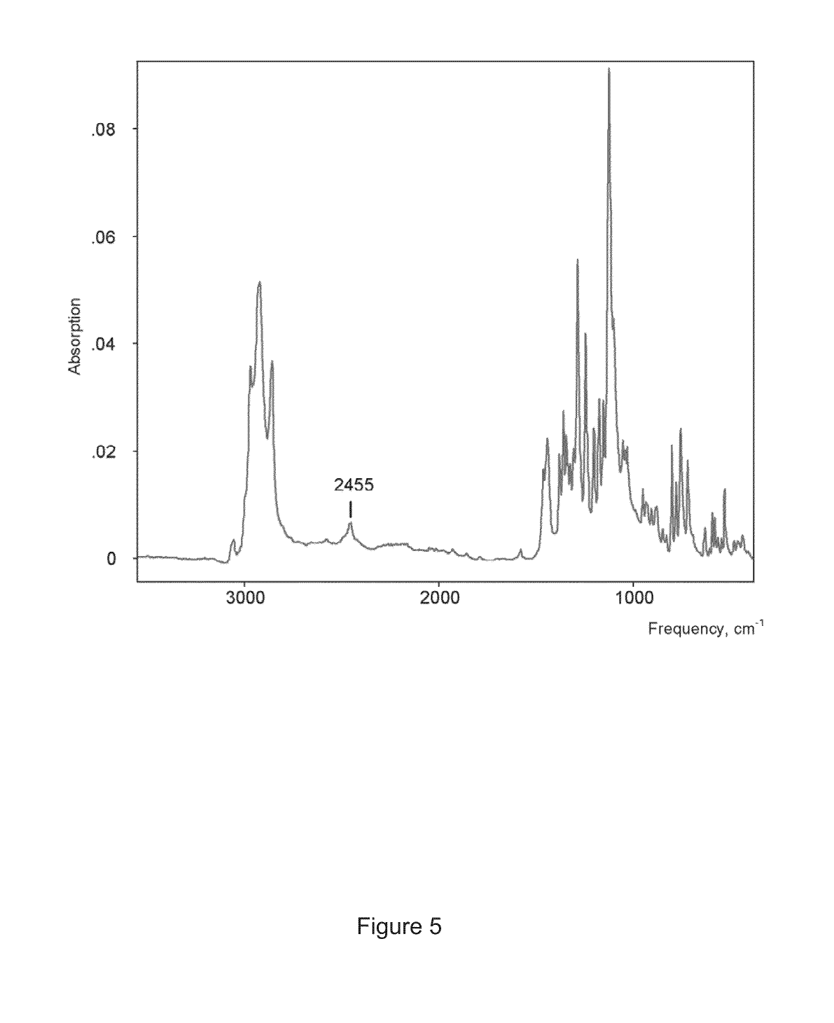

In order to be able to protect the boron center while still having space for coordination of two carbenes, CAAC 1 (V. Lavallo et al., Angew. Chem. Int. Ed., 44, 5705 (2005)), a ligand featuring a bulky 2,6-diisopropylphenyl group at nitrogen and a flexible cyclohexyl moiety as the second carbene substituent was employed (FIG. 1). The first CAAC was installed classically (Y. Wang et al., J. Am. Chem. Soc., 129, 12412 (2007); Y. Wang et al., J. Am. Chem. Soc., 130, 3298 (2008); P. Bissinger et al., Angew. Chem. Int. Ed., 50, 4704 (2011)) by reaction of 1 with BBr₃ in hexane, which afforded the (CAAC)BBr₃ adduct 2 in 94%. Then, in order to observe the putative (CAAC)BH adduct by a second CAAC, a five-fold excess of potassium graphite was added to 1/1 mixture of boron adduct 2 and CAAC 1 in dry toluene. The reaction mixture was stirred at room temperature for 14 hours, and from a complex mixture of products, compound 3 was isolated as a red powder in only 8% yield (FIG. 2). Surprisingly, when the same experiment was carried out in the absence of CAAC 1, the (CAAC)₂BH adduct 3 was also formed, and isolated in 33% yield. The ¹H-decoupled ¹¹B NMR spectrum of 3 demonstrates a broad signal at 12.5 ppm with a half-width of 216 Hz. In the proton-coupled ¹¹B NMR spectrum, no clear splitting but a broadening of the signal with a half-width of 261 Hz was observed. The presence of the hydrogen atom at boron was confirmed by an infrared absorption at 2455 cm⁻¹ (FIG. 5), which can be assigned to the B—H stretching mode. Additional experiments demonstrated that the hydrogen atom is abstracted from an aryl group of a carbene.

In some embodiments, the present invention provides a method of preparing a stable tricoordinate boron in the +1 oxidative state by stabilizing a borylene center with a pair of carbene ligands. The method includes contacting a boron trihalide with a pair of carbene ligands in a hexane to form a solution. The method also includes warming the solution to room temperature with stirring for about 14 hours. The method also includes removing the solvent under vacuum to form a product I. Further, the method includes contacting the product I with KC₈ in toluene with stirring for about 14 hours to form a product II. The methods also includes filtering the KC₈ from the remainder of the product II. The methods includes removing the solvent from the product II, drying the product II under vacuum, and washing the product II with pentane to form a product III.

In other embodiments, the present invention provides a methods as set forth herein further including adding the product III to toluene. The methods also includes contacting the product III in toluene with gallium trichloride with stirring for about 14 hours. The methods further includes removing the volatiles under vacuum. The methods also include extracting the solid residue with acetonitrile. The methods includes removing the solvent under vacuum and drying the solid residue under vacuum.

In some other embodiments, the present invention provides a methods as set forth herein further including contacting trifluoromethanesulfonic acid at room temperature in toluene with product III with stirring for about 14 hours. The method also includes removing volatiles under vacuum.

In any of the methods set forth herein, the contacting a boron trihalide with a pair of carbene ligands in a hexane may occur at −78° C. In other embodiments, the boron trihalide is BBr₃ or BCl₃. In still other embodiments, the boron trihalide is BBr₃. In other embodiments, the pair of carbene ligands are independent of each other a cyclic (alkyl)(amino)carbene. In certain embodiments, the cyclic (alkyl)(amino)carbene has the following structure:

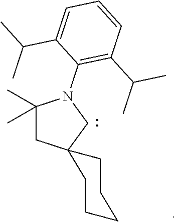

In yet other embodiments, the present invention provides a tricoordinate boron complex prepared in accordance with any of the methods set forth herein.

### VII. Examples

Manipulations were performed under an atmosphere of dry argon using standard Schlenk techniques. Solvents were dried by standard methods and distilled under argon. ¹¹B, and ¹³C NMR spectra were recorded on Varian Inova 500 and Bruker 300 spectrometers at 25° C. NMR multiplicities are abbreviated as follows: s=singlet, d=doublet, t=triplet, sept=septet, m=multiplet, br=broad signal. Melting points were measured with a Buchi melting point apparatus system. EPR spectra were recorded on Bruker EMX at 298 K.

### Crystallization of Complex of Formula I.

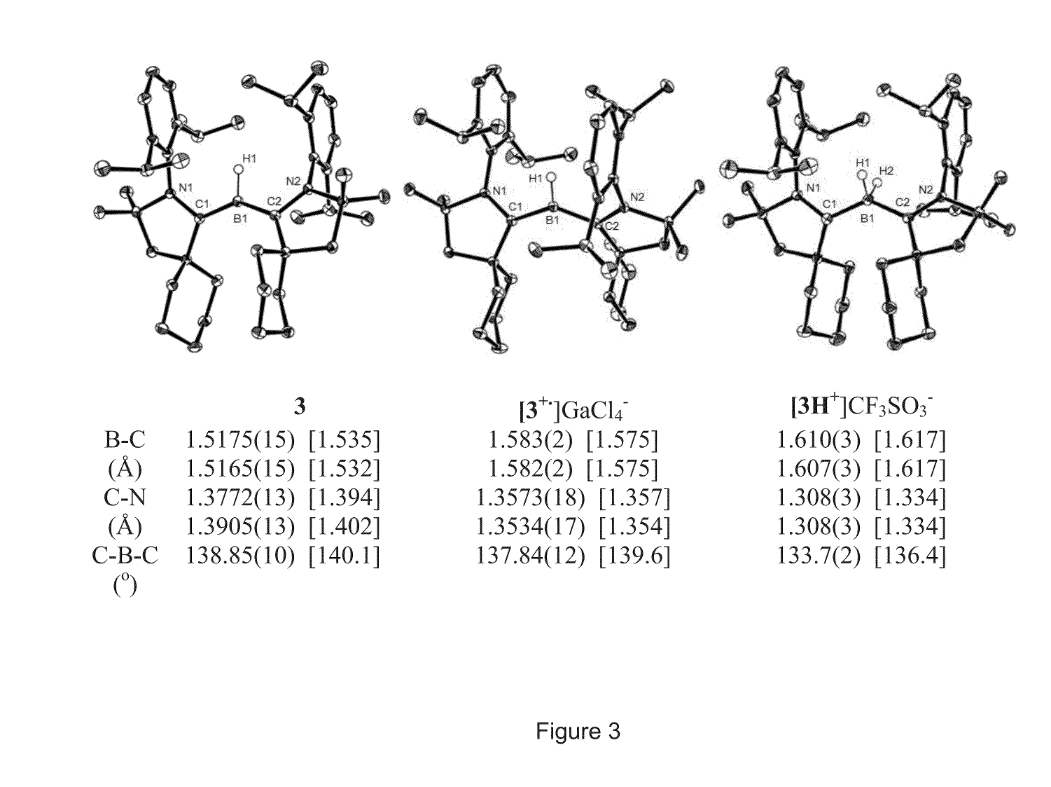

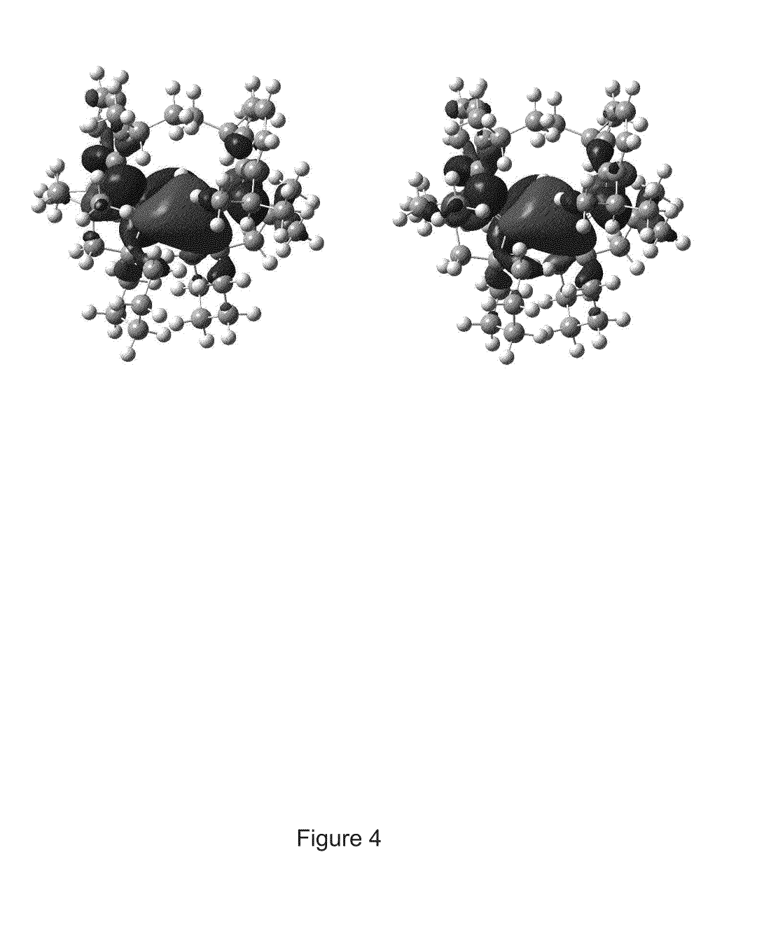

Single crystals suitable for an X-ray diffraction study were obtained by recrystallization from a dry tetrahydrofuran solution at room temperature. In the solid state (FIG. 3, left), the carbene carbons C1 and C2, boron, and the hydrogen H1 are in a perfectly planar arrangement (sum of the bond angles at B: 359.94). The B1-C1 [1.5175(15) Å] and B1-C2 [1.5165(15) Å] bond distances are equal and are halfway between typical B—C single (1.59 Å) and double (1.44 Å) bonds (M. M. Olmstead, P. P. Power, K. J. Weese, J. Am. Chem. Soc., 109, 2541 (1987)), suggesting the delocalization of the lone pair of electrons at boron to the empty p-orbitals of the carbene centers. Ab initio calculations performed on 3 at the BP86/def2-SVP level of theory support this bonding analysis. The carbene→BH donation occurs from the a lone pairs of carbene ligands into the empty in-plane molecular orbital at boron, affording two low-lying orbitals. The HOMO of 3 (−3.34 eV) is essentially an electron lone pair in the p(n)-orbital of boron, which mixes in a bonding fashion with the p(π) atomic orbital of the two carbene carbons (FIG. 4, left). The charge exchange via a donation and π backdonation leaves the BH moiety in 3 with a partial charge of +0.05 e. For comparison, the BH fragment in (CH₃)₂BH, which has two B—C electron-sharing bonds, carries a positive charge of +0.61 e. Therefore, the zwitterionic form 3b, featuring a dianionic boron center (J. Monot et al., Angew. Chem. Int. Ed., 49, 9166 (2010)), is a far weaker resonance contributor than 3a, which shows the parent borylene coordinated by two carbene ligands.

A single crystal X-ray diffraction study showed that the boron center of [3⁺.]GaCl₄⁻ is in a perfectly planar arrangement, as observed for its precursor 3 (FIG. 3, center). However, the boron-carbon and carbon-nitrogen bond distances are longer and shorter, respectively, than those of 3, in line with the weaker electron-donation from boron to the carbene ligand. Compound [3⁺.]GaCl₄⁻ is one of very few crystallographically characterized boron radicals (M. M. Olmstead, P. P. Power, J. Am. Chem. Soc., 108, 4235 (1986)) and molecules featuring boron in the formal +2 oxidation state (R. Dinda et al., Angew. Chem. Int. Ed., 46, 9110 (2007)).

### Cyclic Voltammogram of Complexes of Formulas I, II, or III.

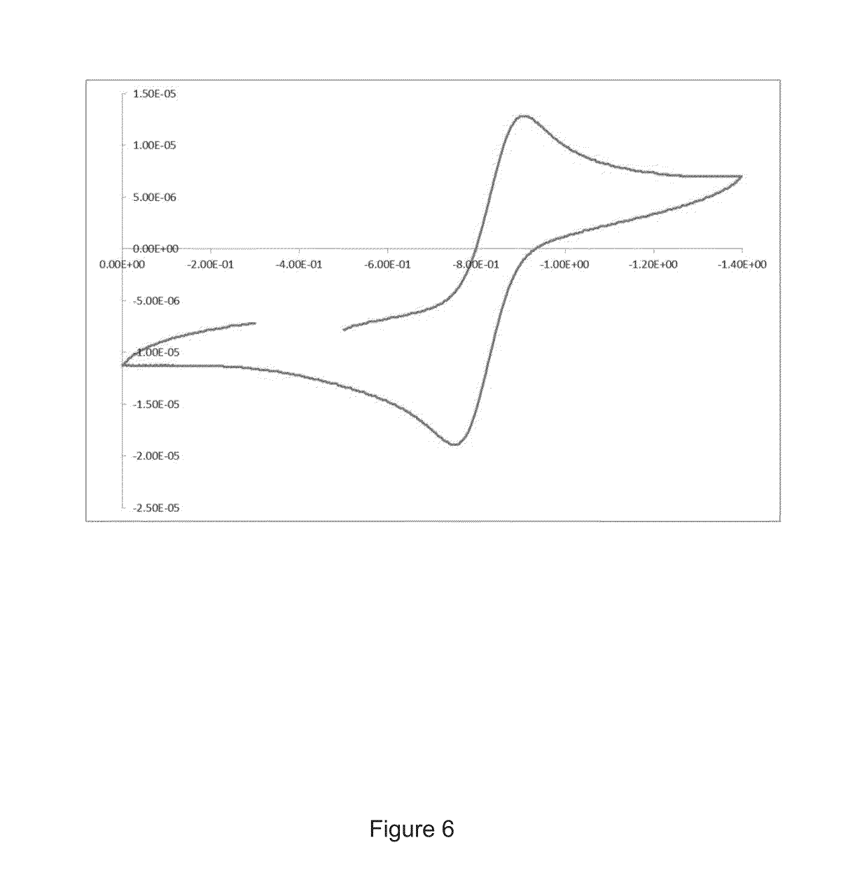

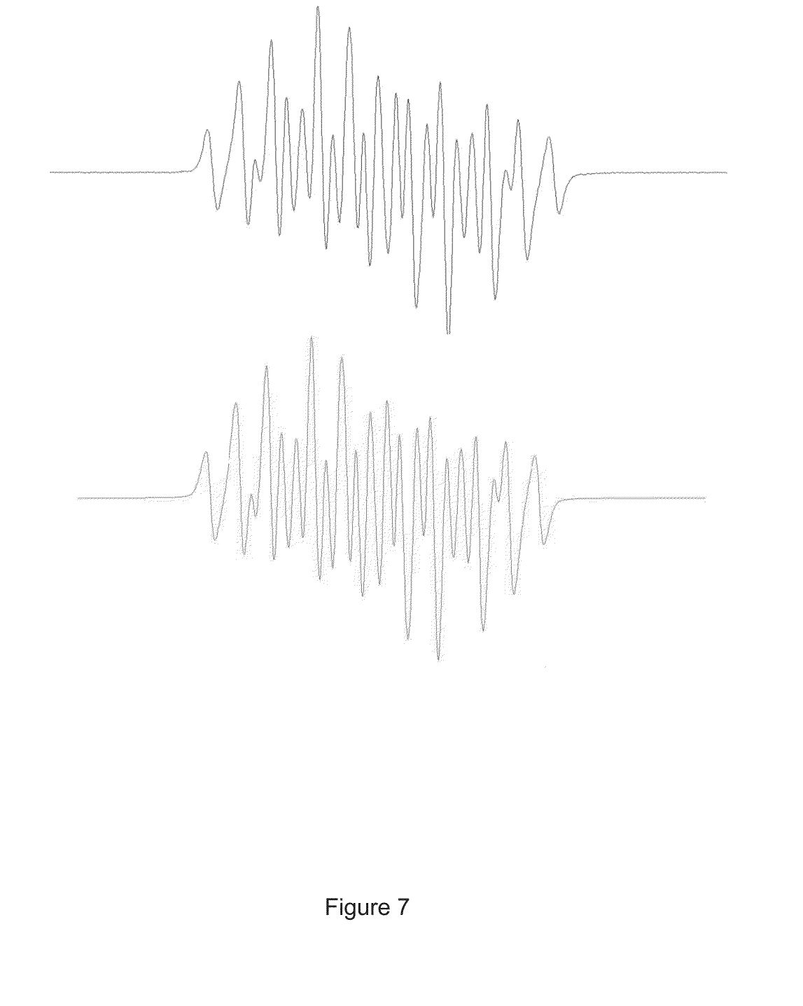

The boron in compound 3 is in the formal oxidation state +1 and is electron-rich. This was confirmed by the cyclic voltammogram (FIG. 6) of a THF solution of 3 [0.1 M nBu₄NPF₆ electrolyte], which shows a reversible one-electron oxidation at E_{1/2}=−0.940 V versus Fc+/Fc [Fc: ferrocene]. Indeed, addition at room temperature of two equivalents of gallium trichloride to a toluene solution of 3 quantitatively afforded the radical cation [3⁺.]GaCl₄⁻. The room temperature electron paramagnetic resonance spectrum in THF solution displays a complex system (g=2.0026) due to the couplings with the boron [a(¹¹B)=6.432 G], hydrogen [a(¹H)=11.447 G], and two nitrogen nuclei [a(¹⁴N)=4.470 G] (FIG. 7). The values of spin couplings with the ¹¹B and ¹H nuclei are similar to those observed in the persistent (NHC)BH₂ radical, whereas the coupling constant with the ¹⁴N nuclei is greater than those in the NHC adducts (T. Matsumoto, F. P. Gabbaï, Organometallics, 28, 4252 (2009); J. C. Walton et al., J. Am. Chem. Soc., 132, 2350 (2010)), in line with the higher electron-acceptor ability of CAACs versus NHCs. Calculations using the natural bond orbital (NBO) method, confirmed that the spin density is mainly located at boron (0.50 e) with some contributions of the nitrogen atoms (0.16 e and 0.17 e). The singly occupied molecular orbital (SOMO) (−7.30 eV) is essentially the boron p-orbital, weakly mixing with the p(n) atomic orbital of the two carbene carbons (FIG. 4, right).

### Acidity and Basicity Studies

Because of the presence of a lone pair of electrons at boron, bis(carbene)BH adduct 3 can react with electrophiles, which is quite unusual for tricoordinate boron compounds (Y. Segawa, M. Yamashita, K. Nozaki, Science, 314, 113 (2006); T. B. Marder, Science, 314, 69 (2006); H. Braunschweig, Angew. Chem. Int. Ed., 46, 1946 (2007); K. Nozaki, Nature, 464, 1136 (2010); M. S. Cheung, T. B. Marder, Z. Lin, Organometallics, doi:10.1021/om200115y; H. Braunschweig et al., Angew. Chem. Int. Ed., 49, 2041 (2010)). No reactions of 3 were observed with trimethylsilyl- or methyl-trifluoromethanesulfonate even after heating at 80° C. for 14 hours, probably due to the presence of the two bulky CAAC ligands, which shield the boron center. To probe basicity further, an equimolar amount of trifluoromethane sulfonic acid was added to a toluene solution of compound 3 at room temperature, and after work up, the conjugate acid [3H⁺]CF₃SO₃⁻ was isolated in 89% yield. The proton-coupled ¹¹B NMR spectrum of this salt shows a triplet (J_{BH}=83.5 Hz) at −21.8 ppm, confirming the presence of two hydrogen atoms directly bonded to boron, and thus the boronium nature (W. E. Piers, S. C. Bourke, K. D. Conroy, Angew. Chem. Int. Ed., 44, 5016 (2005)) of [3H⁺]CF₃SO₃⁻. The solid state structure confirmed the tetracoordination of boron. The boron-carbon and carbon-nitrogen bond distances are in the range of single and double bonds, respectively, in line with the absence of back-donation from boron to the carbene ligand. To quantify the basicity of 3, the gas phase proton affinity was calculated (BP86/def2-SVP+ZPE): the 1108 kJ/mol value is much higher than that calculated for the free BH (856 kJ/mol), and comparable to the unsaturated free N-phenyl substituted NHC (1107 kJ/mol) (R. Tonner, G. Heydenrych, G. Frenking, Chem. Phys. Chem., 9, 1474 (2008)). In toluene solution, we found that 3 is readily protonated by BrCH₂CO₂H, whereas the reaction with PhCO₂H proceeded very slowly, and only trace amounts of [3H⁺]PhCO₂⁻ were detected after 14 hours. Boronium [3H⁺]CF₃SO₃⁻ is rapidly deprotonated by sodium ethoxide in a THF solution giving back 3 in 68% yield, though no reaction was observed with strong but bulky bases such as potassium hexamethyldisilazide, lithium diisopropylamide, or t-butyllithium, confirming the steric shielding of the boron center (Unsuccessful attempts to deprotonate bis(phosphine)BHX adducts (X: H, Br) were reported by M. Sigl, A. Schier, H. Schmidbaur, Chem. Ber., 130, 1411 (1997)).

### Stability Studies

Although the parent borylene adduct 3 and the radical cation [3⁺.]GaCl₄⁻ are sensitive to air, they are stable at room temperature under argon both in solution and in the solid state for two months at least (m.p. 3: 328° C.; [3⁺.]GaCl₄⁻: 278° C.), which strikingly demonstrates the stabilizing efficiency of CAACs. In marked contrast to the well-known tricoordinate boron(+3) derivatives, compound 3, featuring a boron in the +1 oxidation state, behaves as a Lewis base, and can readily be oxidized. Its reactivity with electrophiles is hampered by the bulkiness of the CAAC ligands, but the steric and electronic properties of carbenes can be substantially modulated. Compounds of type 3 are isoelectronic with amines and phosphines, and because of the lower electronegativity of boron, compared to those of nitrogen and phosphorus, they are potential strong electron-donor ligands for transition metals.

### Synthesis of (CAAC)BBr₃ Adduct 2.

Boron tribromide (5.00 g, 20.0 mmol) was added at −78° C. to a hexane solution (200 mL) of CAAC 1 (6.50 g, 20.0 mmol). The reaction mixture was warmed to room temperature and stirred for 14 hours. After the solvent was removed under vacuum, the resulting white solid was washed with pentane, and dried under vacuum to give 2 as a white powder (10.80 g, 94% yield). ¹H NMR (300 MHz, CDCl₃): δ=7.43 (t, ³J=7.8 Hz, 1H, p-CH), 7.25 (d, ³J=7.0 Hz, 4H, m-CH), 3.32-3.16 (m, 2H, CH₂), 2.80 (sept, ³J=6.5 Hz, 2H, CH(CH₃)₂), 2.32 (s, 2H, CH₂), 1.98-1.60 (m, 8H, CH₂), 1.47 (s, 6H, CH₃), 1.41 (d, ³J=6.5 Hz, 6H, CH(CH₃)₂), 1.30 (d, ³J=6.5 Hz, 6H, CH(CH₃)₂); ¹³C NMR (75 MHz, CDCl₃): δ=145.8 (o), 130.4 (p), 125.6 (m), 125.2 (ipso), 80.9 (C^{q}), 61.3 (C^{q}), 45.2 (CH₂), 36.9 (CH₂), 29.7 (CH₃), 29.5 (CH), 26.5 (CH₃), 25.2 (CH₃), 24.7 (CH₂), 23.1 (CH₂); ¹¹B NMR (96 MHz, CDCl₃): δ=−13.5.

Synthesis of bis(CAAC)BH Adduct 3.

Toluene (20 mL) was added at room temperature to a mixture of 2 (1.00 g, 1.74 mmol) and potassium graphite (1.17 g, 8.68 mmol). After stirring for 14 hours, toluene (75 mL) was added to the mixture, and then graphite and KBr were filtered off. After the solvent was removed under vacuum, the solid residue was washed with pentane (100 mL), and dried under vacuum to afford 3 as a red powder (185 mg, 33% yield). Single crystals of 3 were obtained by recrystallization from a THF solution at room temperature. Mp: 328° C. (dec.); IR (solid, cm⁻¹) vₘₐₓ 2455 (B—H), ¹H NMR (500 MHz, toluene-d₈): δ=7.07-6.92 (m, 6H, m-CH and p-CH), 3.34-3.26 (m, 2H, CH₂), 3.09 (sept, ³J=8.3 Hz, 2H, CH(CH₃)₂), 2.75 (sept, ³J=8.3 Hz, 2H, CH(CH₃)₂), 2.60-2.53 (m, 2H, CH₂), 2.13 (s, 2H, CH₂), 2.12 (s, 2H, CH₂), 1.87-1.54 (m, 16H, CH₂), 1.30 (d, ³J=8.3 Hz, 6H, CH(CH₃)₂), 1.27 (d, ³J=8.3 Hz, 6H, CH(CH₃)₂), 1.19 (d, ³J=8.3 Hz, 6H, CH(CH₃)₂), 1.01 (s, 6H, CH₃), 0.99 (s, 6H, CH₃), 0.23 (d, ³J=8.3 Hz, 6H, CH(CH₃)₂); attempts to observe the BH signal by 2D ¹¹B-¹H NMR both in solution and in solid state failed, possibly because of the large quadripolar moment of boron; ¹³C NMR (125 MHz, THF-dₛ): δ=149.3 (o), 147.9 (o), 138.3 (ipso), 127.2 (p), 125.6 (m), 124.4 (m), 68.0 (C^{q}), 51.8 (C^{q}), 43.2 (CH₂), 36.4 (CH₂), 31.7 (CH₂), 30.0 (CH₃), 29.5 (CH), 29.0 (CH₃), 28.2 (CH), 27.0 (CH₃), 25.4 (CH₃), 24.6 (CH₃), 24.4 (CH₃), 24.2 (CH₂×₂), 24.0 (CH₂); ¹¹B NMR (96 MHz, toluene-d₈): δ=12.5 (h_{1/2}=216 Hz). ERMS (ESI): 662.5708 [(M)⁺, 662.5713 (C₄₆H₇₁BN₂)].

### Synthesis of Radical Cation [3+.]GaCl4-.

Toluene (6 mL) was added at room temperature to a mixture of 3 (150 mg, 0.23 mmol) and gallium trichloride (81 mg, 0.46 mmol). After stirring for 14 hours, volatiles were removed under vacuum. The solid residue was extracted with acetonitrile (10 mL), then the solvent was removed under vacuum, and the solid residue dried under vacuum to afford [3⁺.]GaCl₄⁻ as a purple powder (177 mg, 88% yield). Single crystals of [3⁺.]GaCl₄⁻ were obtained by recrystallization from a mixture of THF and toluene (4:1) solution at room temperature. Mp: 278° C. (dec.). HRMS (ESI): 662.5734 [(M)⁺, 662.5713 (C₄₆H₇₁BN₂)]

### Synthesis of Boronium [3H⁺]CF₃SO₃⁻.

Trifluoromethanesulfonic acid (45 mg, 0.30 mmol) was added at room temperature to a toluene (12 mL) solution of 3 (200 mg, 0.30 mmol). After stirring for 14 hours, volatiles were removed under vacuum to afford [3H⁺]CF₃SO₃⁻ as a purple powder (217 mg, 89% yield). Single crystals of [3H⁺]CF₃SO₃⁻ were obtained by recrystallization from a THF solution at room temperature. [3H⁺]CF₃SO₃⁻ decomposes at 246° C. without melting; ¹H NMR (500 MHz, CD₃CN): δ=7.07-7.03 (m, 4H, m-CH), 6.89-6.87 (m, 2H, p-CH), 2.83-2.77 (m, 2H, CH₂), 2.40 (sept, ³J=8.3 Hz, 2H, CH(CH₃)₂), 2.36 (s, 2H, CHH), 1.98-1.91 (m, 2H, CH₂), 2.00 (s, 2H, CHH), 1.99-1.91 (m, 2H, CH₂), 1.86 (sept, ³J=8.3 Hz, 2H, CH(CH₃)₂), 1.77-1.41 (m, 16H, CH₂), 1.18 (s, 6H, CH₃), 1.07 (d, ³J=8.3 Hz, 6H, CH(CH₃)₂), 0.91 (d, ³J=8.3 Hz, 6H, CH(CH₃)₂), 0.87 (s, 6H, CH3), −0.11 (d, ³J=8.3 Hz, 6H, CH(CH₃)₂), BH was not found; ¹³C NMR (125 MHz, CD₃CN): δ=145.9 (o), 143.7 (o), 133.9 (ipso), 130.3 (p), 126.69 (m), 126.66 (m), 79.9 (C^{q}), 58.1 (C^{q}), 47.3 (CH₂), 36.6 (CH₂), 31.7 (CH₂), 30.4 (CH₃), 30.0 (CH), 29.9 (CH₃), 29.5 (CH), 27.4 (CH₃), 26.3 (CH₃), 24.6 (CH₃), 24.4 (CH₃), 24.2 (CH₂), 22.4 (CH₂), 22.2 (CH₂); ¹¹B NMR (96 MHz, THF-d_{g}): δ=−21.8 (t, ¹J_{BH}=83.5 Hz, BH₂); ¹⁹F NMR (282 MHz, CD₃CN) δ=−80.9; HRMS (ESI): 663.5791 [(M+H)⁺, 663.5791 (C₄₆H₇₂BN₂)].

Deprotonation of Boronium [3H⁺]CF₃SO₃⁻ with NaOEt.

THF (8 mL) was added at room temperature to a mixture of [3H⁺]CF₃SO₃⁻ (100 mg, 0.12 mmol) and sodium ethoxide (10 mg, 0.15 mmol). After stirring for 14 hours, volatiles were removed under vacuum, and then toluene (12 mL) was added to the residue. NaOTf was filtered off, the solvent was removed under vacuum, and the solid residue dried under vacuum to afford 3 (54 mg, 68% yield).

### Crystal Structure Determination for Compounds 3, [3+.]GaCl4-, and [3H+]CF3SO3-

The Bruker X8-APEX X-ray diffreaction instrument with Mo-radiation was used for data collection of compounds 3, [3⁺.]GaCl₄⁻, and [3H⁺]CF₃SO₃⁻. All data frames were collected at low temperatures (T=95 and 100 K) using an ω, φ-scan mode (0.3° (ω-scan width, hemisphere of reflections) and integrated using a Bruker SAINTPLUS software package. The intensity data were corrected for Lorentzian polarization. Absorption corrections were performed using the SADABS program. The SIR97 was used for direct methods of phase determination, and Bruker SHELXTL software package for structure refinement and difference Fourier maps. Atomic coordinates, isotropic and anisotropic displacement parameters of all the non-hydrogen atoms of three compounds were refined by means of a full matrix least-squares procedure on F₂. All H-atoms were included in the refinement in calculated positions riding on the C atoms, with U[iso] fixed at 20% higher than isotropic parameters of carbons atoms which they were attached. Drawings of molecules were performed using Ortep 3 and POVRay for Windows.

Metrical data for the solid state structure of 3, [3⁺.]GaCl₄⁻, and [3H⁺]CF₃SO₃⁻ are available free of charge from the Cambridge Crystallographic Data Centre under reference numbers CCDC-822247, CCDC-822248, and CCDC-822249, respectively.

TABLE 1
Crystallographic Data and Summary of Data Collection and Structure Refinement.

| | 3 | [3^{+.}]GaCl₄⁻ | [3H+]CF₃SO₃⁻ (thf) |
|---|---|---|---|
| Formula | C₄₆H₇₁BN₂ | C₄₆H₇₁BC1₄GaN₂ | C₅₄H₈₀BF₃N₂O₄S |
| Fw | 662.86 | 874.38 | 885.04 |
| cryst syst | Triclinic | Orthorhombic | Triclinic |
| space group | P-1 | Pbca | P-1 |
| Size (mm³) | 0.32 × 0.17 × 0.10 | 0.30 × 0.15 × 0.10 | 0.28 × 0.16 × 0.11 |
| T, K | 95(2) | 100(2) | 100(2) |
| a, Å | 9.7734(5) | 18.572(4) | 9.1737(3) |
| b, Å | 11.1866(6) | 17.687(4) | 12.1411(4) |
| C, Å | 19.8762(11) | 29.302(7) | 22.2368(7) |
| α, deg | 99.287(3) | 90.000 | 77.971(2) |
| β, deg | 93.936(3) | 90.000 | 80.416(2) |
| γ, deg | 110.830(3) | 90.000 | 86.380(2) |
| V, A³ | 1985.63(18) | 9625(4) | 2387.48(13) |
| Z | 2 | 8 | 2 |
| d_{calcd} g · cm⁻³ | 1.109 | 1.207 | 1.231 |
| μ, mm⁻¹ | 0.062 | 0.825 | 0.126 |
| Refl collected | 31039 | 49691 | 11833 |
| N_{measd} | 12701 | 13930 | 9947 |
| [Rᵢₙₜ] | [0.0463] | [0.0504] | [0.0400] |
| R[I > 2sigma(I)] | 0.0552 | 0.0435 | 0.0713 |
| R_{w}[I > 2sigma(I)] | 0.1613 | 0.1231 | 0.1806 |
| GOF | 1.012 | 1.056 | 1.192 |
| Largest diff | 0.587/−0.334 | 0.924/−0.523 | 0.859/−0.382 |
| peak/hole[e−Å⁻³] | | | |

### Computational Details

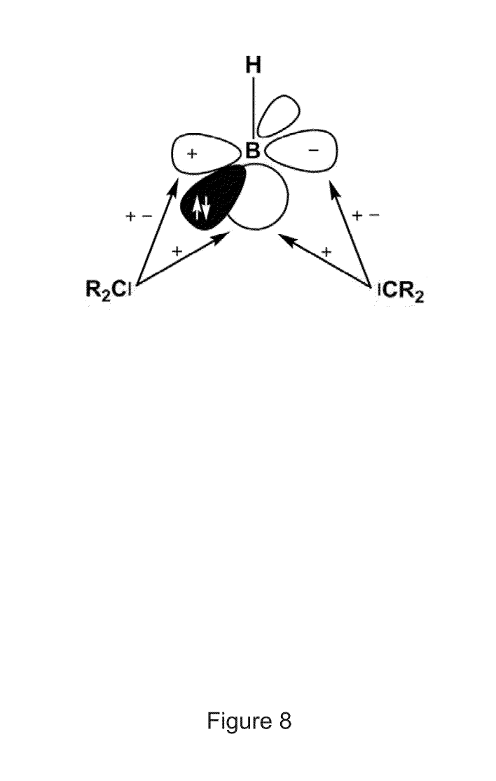

FIG. 8 below shows schematically the bonding situation in (BH)(CAAC)₂ 3. The carbine→BH donation occurs from the σ lone pair of the carbene ligands into the empty in-plane sp and p molecular orbitals at boron. The totally symmetric (+) combination of the r lone pairs donates charge into the empty sp(σ) orbital of BH, while the antisymmetric (+ −) combination donates charge into the vacant in-plane p(π) molecular orbital of boron. Thus, the electronic reference state of the BH fragment in (CAAC)₂BH 3 is not the X¹Σ⁺ ground state as in the free borylene BH, which has a doubly occupied sp(∝) orbital, but it is the excited C¹Δ state with a p(π) lone-pair (39). The (CAAC)→(BH)←(CAAC) σ donation is complemented by π backdonation from the p(π) lone-pair orbital of BH, which mixes in a bonding fashion with the p(π) atomic orbital of the two carbene carbons, yielding the energetically high-lying HOMO of 3 (−3.34 eV). The boron-carbon bonds in 3 are rather strong. The calculations at BP86/def2-SVP predict a bond dissociation energy (BDE) for the reaction 3→(X¹Σ⁺) BH+2 CAAC a value of Dₒ=665 kJ/mol which gives a mean BDE of Dₒ=332.5 kJ/mol for each C→B donor-acceptor bond. This may be compared with the calculated BDE for the carbon-boron bond in the complex NHC(BH₃) which is only Dₒ=245 kJ/mol.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. A tricoordinate borylene complex, having the following structure: 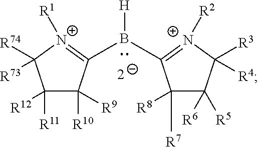
wherein R¹ and R² are independently selected from the group consisting of alkyl, aryl, arylalkyl, cycloalkyl, cycloalkylalkyl, heteroaryl, heteroarylalkyl, heterocycloalkyl, and heterocycloalkylalkyl;
wherein R⁷, R⁸, R⁹, and R¹⁰ are independently selected from the group consisting of hydrogen, alkyl, aryl, arylalkyl, cycloalkyl, cycloalkylalkyl, heteroaryl, heteroarylalkyl, heterocycloalkyl, and heterocycloalkylalkyl;
wherein at least one of R⁷ and R⁸ is other than hydrogen;
wherein at least one of R⁹ and R¹⁰ is other than hydrogen;
wherein R³, R⁴, R⁵, R⁶, R¹¹, R¹², R¹³, and R¹⁴ are independently selected from the group consisting of hydrogen, acyl, alkyl, alkoxy, amino, aryl, arylalkyl cyano, cycloalkyl, cycloalkylalkyl, halo, heteroaryl, heteroarylalkyl, heterocycloalkyl, heterocycloalkylalkyl, hydroxyl, and nitro; and
wherein R¹, R², R³, R⁴, R⁵, R⁶, R⁷, R⁸, R⁹, R¹⁰, R¹¹, R¹², R¹³, and R¹⁴ are independently optionally substituted with 1-5 substituents selected from the group consisting of alkyl, alkoxy, amino, aryl, cycloalkyl, halo, heteroaryl, hydroxyl, and nitro;
or a salt, hydrate, or isomer thereof.

2. The complex of claim 1, having the following structure: 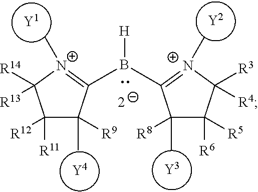
wherein Y¹, Y², Y³, and Y⁴ are independently selected from the group consisting of aryl, arylalkyl, cycloalkyl, and cycloalkylalkyl; and
wherein Y¹, Y², Y³, and Y⁴ are independently optionally substituted with from 1-5 substituents selected from the group consisting of alkyl, aryl, halo, heteroaryl, and hydroxyl.

3. The complex of claim 2, having the following structure: 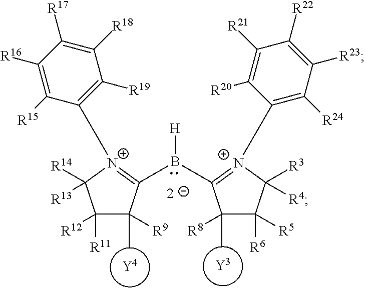
wherein R¹⁵, R¹⁶, R¹⁷, R¹⁸, R¹⁹, R²⁰, R²¹, R²², R²³, and R²⁴ are independently selected from the group consisting of hydrogen, acyl, alkyl, alkoxy, amino, cyano, halo, and nitro.

4. The complex of claim 3, having the following structure:

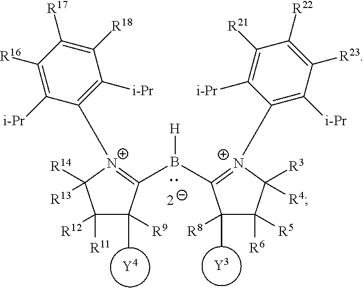

5. The complex of claim 2, having the following structure:

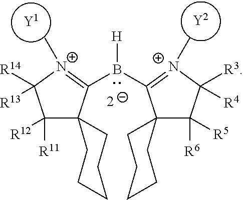

6. The complex of claim 5, having the following structure:

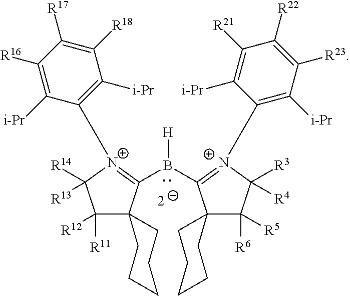

7. The complex of claim 6, having the following structure:

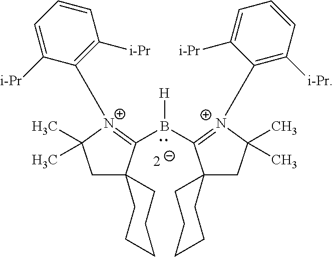 [SMILES: CC(C)c1cccc(C(C)C)c1[N+]1=C(BC2=[N+](c3c(C(C)C)cccc3C(C)C)C(C)(C)CC23CCCCC3)C2(CCCCC2)CC1(C)C]

8. The complex of claim 7, having the following resonance structure:

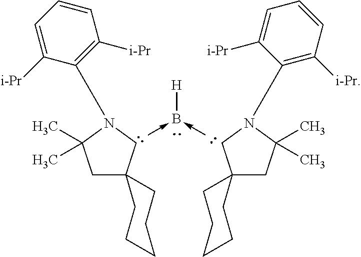

9. A stable borinylium radical, having the following structure: 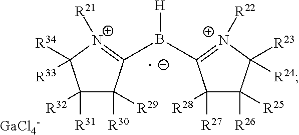
wherein R²¹ and R²² are independently selected from the group consisting of alkyl, aryl, arylalkyl, cycloalkyl, cycloalkylalkyl, heteroaryl, heteroarylalkyl, heterocycloalkyl, and heterocycloalkylalkyl;
R²⁷, R²⁸, R²⁹, and R³⁰ are independently selected from the group consisting of hydrogen, alkyl, aryl, arylalkyl, cycloalkyl, cycloalkylalkyl, heteroaryl, heteroarylalkyl, heterocycloalkyl, and heterocycloalkylalkyl;
wherein at least one of R²⁷ and R²⁸ is other than hydrogen;
wherein at least one of R²⁹ and R³⁰ is other than hydrogen;
wherein R²³, R²⁴, R²⁵, R²⁶, R³¹, R³², R³³, and R³⁴ are independently selected from the group consisting of hydrogen, acyl, alkyl, alkoxy, amino, aryl, arylalkyl, cyano, cycloalkyl, cycloalkylalkyl, halo, heteroaryl, heteroarylalkyl, heterocycloalkyl, heterocycloalkylalkyl, hydroxyl, and nitro; and
wherein R²¹, R²², R²³, R²⁴, R²⁵, R²⁶, R²⁷, R²⁸, R²⁹, R³⁰, R³¹, R³², R³³, and R³⁴ are independently optionally substituted with 1-5 substituents selected from the group consisting of alkyl, alkoxy, amino, aryl, cycloalkyl, halo, heteroaryl, hydroxyl, and nitro;
or a hydrate or isomer thereof.

10. The radical of claim 9, having the following structure: 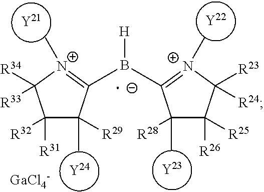
wherein Y²¹, Y²², Y²³, and Y²⁴ are independently selected from the group consisting of aryl, arylalkyl, cycloalkyl, and cycloalkylyl; and
wherein Y²¹, Y²², Y²³, and Y²⁴ are independently optionally substituted with from 1-5 substituents selected from the group consisting of alkyl, aryl, halo, heteroaryl, and hydroxyl.

11. The radical of claim 10, having the following structure: 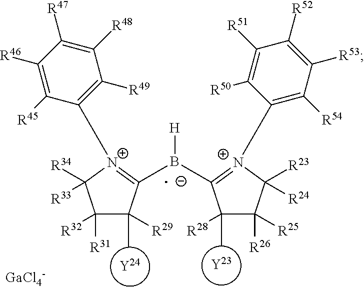
wherein R⁴⁵, R⁴⁶, R⁴⁷, R⁴⁸, R⁴⁹, R⁵⁰, R⁵¹, R⁵², R⁵³, and R⁵⁴ are independently selected from the group consisting of hydrogen, halo, acyl, alkyl, alkoxy, amino, cyano, and nitro.

12. The radical of claim 11, having the following structure:

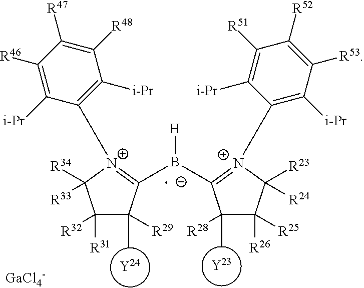

13. The radical of claim 10, having the following structure:

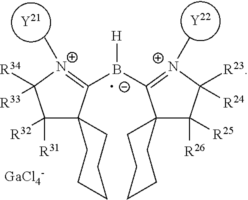

14. The radical of claim 13, having the following structure:

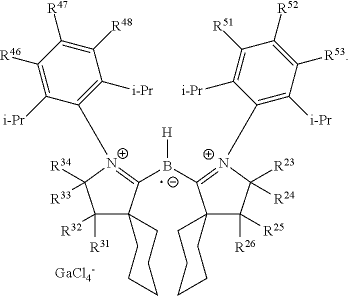

15. The radical of claim 14, having the following structure:

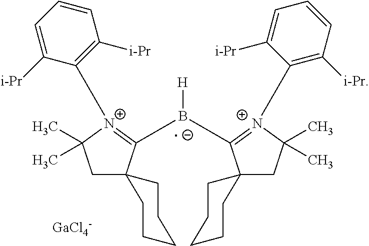

16. The radical of claim 15, having the following resonance structure:

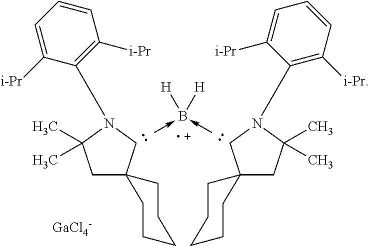

17. A boronium salt, having the following structure: 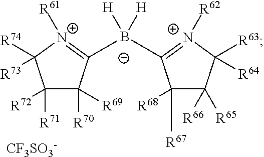
wherein R⁶¹ and R⁶² are independently selected from the group consisting of alkyl, aryl, arylalkyl, cycloalkyl, cycloalkylalkyl, heteroaryl, heteroarylalkyl, heterocycloalkyl, and heterocycloalkylalkyl;
R⁶⁷, R⁶⁸, R⁶⁹, and R⁷⁰ are independently selected from the group consisting of hydrogen, alkyl, aryl, arylalkyl, cycloalkyl, cycloalkylalkyl, heteroaryl, heteroarylalkyl, heterocycloalkyl, and heterocycloalkylalkyl;
wherein at least one of R⁶⁷ and R⁶⁸ is other than hydrogen;
wherein at least one of R⁶⁹ and R⁷⁰ is other than hydrogen;
R⁶³, R⁶⁴, R⁶⁵, R⁶⁶, R⁷¹, R⁷², R⁷³, and R⁷⁴ are independently selected from the group consisting of hydrogen, acyl, alkyl, alkoxy, amino, aryl, arylalkyl, cyano, cycloalkyl, cycloalkylalkyl, halo, heteroaryl, heteroarylalkyl, heterocycloalkyl, heterocycloalkylalkyl, hydroxyl, and nitro; and
wherein R⁶¹, R⁶², R⁶³, R⁶⁴, R⁶⁵, R⁶⁶, R⁶⁷, R⁶⁸, R⁶⁹, R⁷⁰, R⁷¹, R⁷², R⁷³, and R⁷⁴ are independently optionally substituted with 1-5 substituents selected from the group consisting of alkyl, alkoxy, amino, aryl, cycloalkyl, halo, heteroaryl, hydroxyl, and nitro;
or a hydrate or isomer thereof.

18. The salt of claim 17, having the following structure: 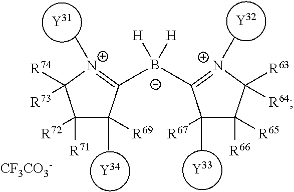
wherein Y³¹, Y³², Y³³, and Y³⁴ are independently selected from the group consisting of aryl, arylalkyl, cycloalkyl, and cycloalkylyl; and
wherein Y³¹, Y³², Y³³, and Y³⁴ are independently optionally substituted with from 1-5 substituents selected from the group consisting of alkyl, aryl, halo, heteroaryl, and hydroxyl.

19. The salt of claim 18, having the following structure: 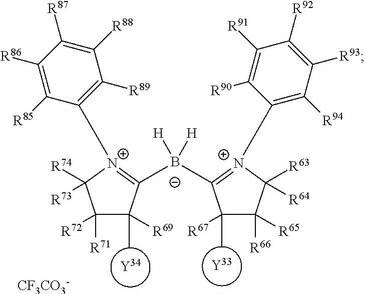
wherein R⁸⁵, R⁸⁶, R⁸⁷, R⁸⁸, R⁸⁹, R⁹⁰, R⁹¹, R⁹², R⁹³, and R⁹⁴ are independently selected from the group consisting of hydrogen, halo, acyl, alkyl, alkoxy, amino, cyano, and nitro.

20. The salt of claim 19, having the following structure:

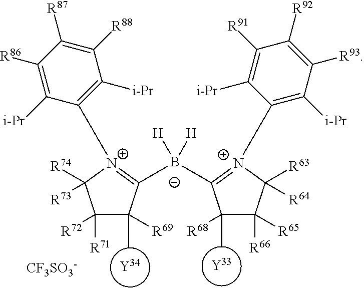

21. The salt of claim 18, having the following structure:

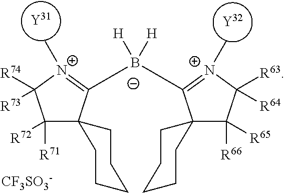

22. The salt of claim 21, having the following structure:

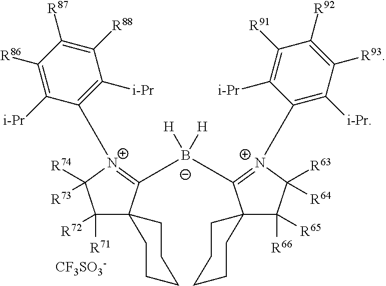

23. The salt of claim 22, having the following structure:

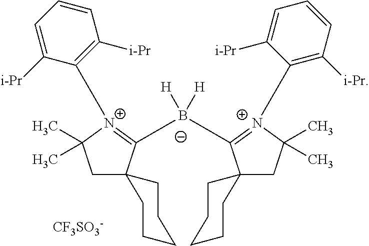 [SMILES: "CF3SO3-" ; CC(C)c1cccc(C(C)C)c1[N+]1=C([BH2-]C2=[N+](c3c(C(C)C)cccc3C(C)C)C(C)(C)CC23CCCCC3)C2(CCCCC2)CC1(C)C]

24. The salt of claim 23, having the following resonance structure:

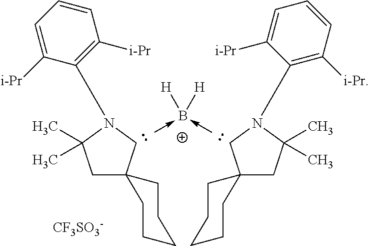

25. A transition metal complex comprising a transition metal and a complex of claim 1.

26. A transition metal complex of claim 25, wherein the boron in the complex is in the +1 oxidative state and is isoelectronic with an amine.

27. A transition metal complex of claim 25, wherein the boron in the complex is in the +1 oxidative state and is substantially as provided in FIG. 2.

28. A method of preparing a stable tricoordinate boron in the +1 oxidative state by stabilizing a borylene center with a pair of carbene ligands, comprising
contacting a boron trihalide with a pair of carbene ligands in a hexane at about −78° C. to form a solution;
warming the solution to room temperature with stirring for about 14 hours;
removing the solvent under vacuum to form a product I;
contacting the product I with KC₈ in toluene with stirring for about 14 hours to form a product II;
filtering the KC₈ from the product II;
removing the solvent from the product II;
drying the product II under vacuum;
washing the product II with pentane to form a product III.

29. The method of claim 28, further comprising
adding the product III to toluene;
contacting the product III in toluene with gallium trichloride with stirring for about 14 hours;
removing the volatiles under vacuum;
extracting the solid residue with acetonitrile;
removing the solvent under vacuum; and
drying the solid residue under vacuum.

30. The method of claim 28, further comprising
contacting trifluoromethanesulfonic acid at room temperature in toluene with product III with stirring for about 14 hours; and
removing volatiles under vacuum.

31. The method of claim 28, wherein the boron trihalide is BBr₃ or BCl₃.

32. The method of claim 31, wherein the boron trihalide is BBr₃.

33. The method of claim 28, wherein said pair of carbene ligands are independent of each other a cyclic (alkyl)(amino)carbene.

34. The method of claim 33, wherein the cyclic (alkyl)(amino)carbene has the following structure:

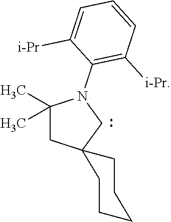

35. A tricoordinate boron prepared in accordance with claim 28.

36. A method of catalyzing a reaction comprising combining a reactant with the transition metal complex of any of claim 25, 26, or 27, under conditions sufficient for catalysis to occur.

37. A neutral tricoordinate boron compound featuring a lone pair at boron, having the following formula: R¹⁰⁰B(L¹)(L²);
wherein R¹⁰⁰ is selected from the group consisting of hydrogen, alkyl, alkoxy, aryl, arylalkyl, aryloxy, cycloalkyl, cycloalkylalkyl, heteroaryl, heteroarylalkyl, heterocycloalkyl, and heterocycloalkylalkyl; and
wherein L¹ and L² are Lewis bases selected from the group consisting of carbenes, phosphines, and amines;
or a salt, hydrate, or isomer thereof.

38. The compound of claim 37, wherein L¹ and L² are independently selected from CAACs.
